(19) United States
(12) Patent Application Publication
(10) Pub. No.: US 2013/0314766 A1
(43) Pub. Date: Nov. 28, 2013

(54) WAVELENGTH CONVERSION CRYSTAL, AND A LIGHT SOURCE COMPRISING THE SAME

(71) Applicants: Tuomas Vallius, Tampere (FI); Janne Konttinen, Tampere (FI); Pietari Tuomisto, Tampere (FI)

(72) Inventors: Tuomas Vallius, Tampere (FI); Janne Konttinen, Tampere (FI); Pietari Tuomisto, Tampere (FI)

(73) Assignee: EpiCrystals Oy, Tampere (FI)

(21) Appl. No.: 13/991,099

(22) PCT Filed: Dec. 1, 2011
(86) PCT No.: PCT/FI11/51070

§ 371 Date: Aug. 12, 2013

Related U.S. Application Data
(60) Provisional application No. 61/418,478, filed on Dec. 1, 2010.
(60) Provisional application No. 61/491,007, filed on May 27, 2011.

(51) Int. Cl. G02F 1/355

(52) U.S. Cl. CPC G02F 1/3551
USPC 359/326; 252/584

(57) ABSTRACT

A nonlinear crystal includes a plurality of poled zones implemented in a nonlinear material. The crystal has a first region and a second region. In the first region, the local average of a length of a period of the poled zones substantially increases with increasing distance from an origin. In the second region, the local average of the length of the period of the poled zones substantially decreases with increasing distance from the origin. The origin is located at an end of the crystal.

### FIELD OF THE INVENTION

The present invention relates to a nonlinear crystal for wavelength conversion. The present invention also relates to a light source comprising a nonlinear crystal.

### BACKGROUND

It is known that visible light may be generated by frequency-doubling in a nonlinear crystal.

It is known that the nonlinear crystal may be periodically poled in order to increase conversion efficiency.

However, small spectral deviations from an optimum wavelength may cause drastic reduction in conversion efficiency of the nonlinear crystal.

### SUMMARY

An object of the present invention is to provide a nonlinear crystal. An object of the invention is to provide a method for manufacturing a nonlinear crystal. An object of the present invention is to provide a light source comprising a nonlinear crystal. An object of the invention is to provide a method for generating light by a nonlinear crystal.

According to a first aspect of the invention, there is provided a nonlinear crystal according to claim 1.

According to a second aspect of the invention, there is provided a light source according to claim 17.

According to a third aspect of the invention, there is a method for generating light according to claim 22.

According to a fourth aspect of the invention, there is a method for producing a nonlinear crystal according to claim 25.

Further aspects of the invention are defined in the other claims.

The nonlinear crystal may convert energy of first light having a first wavelength into second light having a second different wavelength. The nonlinear crystal may be poled in order to increase conversion efficiency. The nonlinear crystal may have a first region and a second region such that the lengths of the poling periods increase with increasing distance from an origin in the first region, and the lengths of the poling periods decrease with increasing distance in the second region.

In an embodiment, the nonlinear crystal has a first region, a second region, and a third region such that the second region is located between the first region and the third region. The lengths of the poling periods may increase with increasing distance from the origin in the first region and in the third region. The lengths of the poling periods may decrease with increasing distance in the second region.

Thus, the lengths of the period of the poled zones of a nonlinear crystal may be different in different locations such that the spectral conversion efficiency curve has a desired form and width. In particular, lengths of the periods of the poled zones at different locations of the crystal may be selected such that the spectral conversion efficiency curve has a substantially wide and substantially flat top.

The nonlinear crystal may provide second light B2 from first light B1 by second harmonic generation (SHG). Consequently, small deviations of the wavelength of the first light from a central wavelength do not cause excessive reduction in the optical power provided after second harmonic generation (SHG). Consequently, small deviations of the wavelength of the first light from a central wavelength do not cause excessive fluctuations in the optical power provided after second harmonic generation (SHG).

In an embodiment, high conversion efficiency may be provided even when the first light coupled into the crystal has a wide spectral width.

In an embodiment, the wide bandwidth of the conversion efficiency curve may improve temperature stability of a light source comprising the crystal. In particular, variations in the intensity of the second light caused by a temperature-induced shift of the wavelength of the first light may be reduced.

### BRIEF DESCRIPTION OF THE DRAWINGS

In the following examples, the embodiments of the invention will be described in more detail with reference to the appended drawings in which

FIG. 1 shows, by way of example, in a side view, generating light by using a crystal comprising nonlinear material,

FIG. 2 shows, by way of example, in a side view, a nonlinear crystal comprising poled zones,

FIG. 3a shows, by way of example, location-dependent length of poled periods,

FIG. 3b shows, by way of example, location-dependent length of poled periods,

FIG. 3c shows, by way of example, location-dependent length of poled periods,

FIG. 4 shows, by way of example, location-dependent length of poled zones,

FIG. 5a shows a conversion efficiency function provided by spatially constant poling period length,

FIG. 5b shows an ideal conversion efficiency function,

FIG. 5c shows, by way of example, conversion efficiency as a function of wavelength of first light,

FIG. 5d shows parameters which may be used to characterize a conversion efficiency function,

FIG. 6a shows, by way of example, conversion efficiency as a function of wavelength of input light for a linearly chirped crystal,

FIG. 6b shows, by way of example, location-dependent length of poled zones for the crystal of FIG. 6a,

FIG. 7a shows, by way of example, an iterative Fourier transform algorithm for determining a phase modulation function,

FIG. 7b shows, by way of example, an iterative Fourier transform algorithm for determining a phase modulation function,

FIG. 7c shows, by way of example, steps of an iterative Fourier transform algorithm,

FIG. 8a shows, by way of example, in a three-dimensional view, a poled crystal comprising waveguides,

FIG. 8b shows, by way of example, in a three-dimensional view, a poled crystal comprising waveguides,

FIG. 8c shows, by way of example, in a three-dimensional view, a poled crystal comprising waveguides,

FIG. 8d shows, by way of example, a method for producing waveguiding ridges

FIG. 9a shows, by way of example, in a side view, a light source comprising a nonlinear crystal,

FIG. 9b shows, by way of example, in a three-dimensional view, a light source comprising a nonlinear crystal,

FIG. 10 shows, by way of example, in a side view, a light source having a folded configuration,

FIG. 11 shows, by way of example, in a side view, optical feedback to a light emitting unit,

FIG. 12a shows, by way of example, in a side view, a Bragg grating implemented on a waveguide layer in order to provide optical feedback,

FIG. 12b shows, by way of example, in a side view, a Bragg grating covered by a protective layer,

FIG. 12c shows, by way of example, in a side view, a Bragg grating implemented under a waveguide layer,

FIG. 12d shows, by way of example, in a side view, a Bragg grating implemented in a waveguide layer,

FIG. 12e shows, in a three dimensional view, a light source comprising a nonlinear crystal,

FIG. 13 shows, by way of example, spectral reflectance of an optical feedback structure,

FIG. 14a shows, by way of example, varying the lengths of the periods of a Bragg grating as a function of location,

FIG. 14b shows, by way of example, an iterative Fourier transform algorithm for determining a phase modulation function,

FIG. 15 shows, by way of example, in a side view, a resonant grating arranged to provide optical feedback,

FIG. 16 shows a display device comprising a light source,

FIG. 17a shows, by way of example, a constant period length and a linearly increasing period length,

FIG. 17b shows, by way of example, two types of non-linearly increasing functions,

FIG. 17c shows, by way of example, two types of non-linearly increasing functions, and

FIG. 18 shows, by way of example, varying the period length between two different values such that the locally averaged period length varies smoothly as a function of the distance from the origin.

### DETAILED DESCRIPTION

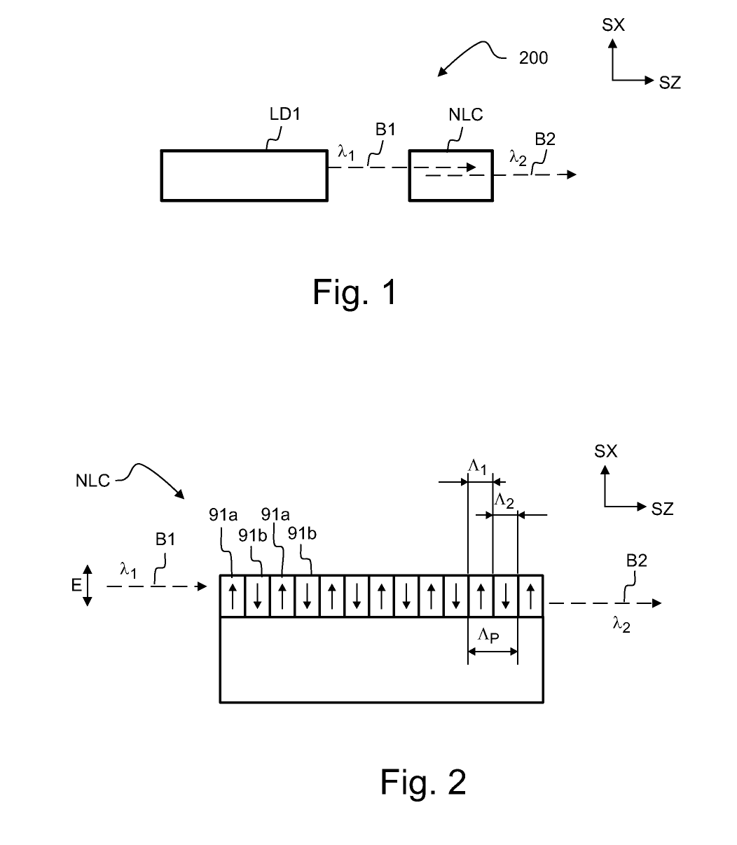

Referring to FIG. 1, second light B2 may be generated from first light B1 by sum frequency generation (SFG) in a nonlinear material, in particular by second harmonic generation (SHG). A crystal NLC may comprise optically nonlinear material. The crystal NLC may be called as a nonlinear crystal.

In this context, the term “nonlinear” refers to the nonlinear optical property of the crystal or optical material. The term nonlinear does not refer to the geometrical form of the crystal. In particular, a nonlinear crystal may have a straight geometrical form.

In case of wide band conversion, sum frequency generation (SFG) may dominate over second harmonic generation (SHG). For example, optical energy generated by sum frequency generation (SFG) may be higher than optical energy generated by second harmonic generation (SHG). For example, more than 50% of optical energy of the first light B1 may be converted into optical energy of the second light B2 by sum frequency generation (SFG) when the Δλ_{FWHM,B1} of the first light B1 is greater than or equal to 0.5 nm. For example, less than 50% of optical energy of the first light B1 may be converted into optical energy of the second light B2 by second harmonic generation (SHG) when the Δλ_{FWHM,B1} of the first light B1 is greater than or equal to 0.5 nm. Δλ_{FWHM,B1} indicates the spectral width of the first light B1. The acronym FWHM denotes the full width at half maximum.

The first light B1 may be e.g. infrared light (wavelength in vacuum longer than 760 nm), and the second light B2 may be visible light (wavelength in vacuum in the range of 400 nm to 760 nm). Alternatively, the first light B1 may be e.g. visible light (wavelength in vacuum in the range of 400 nm to 760 nm), and the second light may be ultraviolet light (wavelength in vacuum shorter than 400 nm).

The first light B1 and the second light B2 may be pulsed in order to increase conversion efficiency and/or in order to reduce speckle patterns.

Referring to FIG. 1, a light source 200 may comprise a light emitting unit LD1 and a nonlinear crystal NLC. Infrared light B1 provided by the light emitting unit LD1 may be coupled into the nonlinear crystal NLC. Visible light B2 may be generated in the nonlinear crystal NLC by frequency conversion. The light B1 has a wavelength λ₁. The light B2 has a wavelength λ₂. The optical frequency corresponding to the wavelength λ₂ may be substantially equal to two times an optical frequency corresponding to the wavelength λ.

The crystal NLC may comprise e.g. optical waveguides, grating structures, antireflection coatings and/or protective coatings. The nonlinear crystal NLC may also be called as a wavelength conversion device NLC or a wavelength conversion unit NLC.

SX, SY and SZ denote orthogonal directions. The lights B1 and B2 may propagate substantially in the direction SZ through the nonlinear crystal NLC.

Referring to FIG. 2, the nonlinear crystal NLC may be (periodically) poled in order to provide quasi-phase-matching conditions. Quasi-phase-matching may increase conversion efficiency.

The crystal NLC may comprise ferroelectric material, which has been poled by using a spatially periodic electric field in a manufacturing step. Consequently, the nonlinear crystal NLC may comprise regularly spaced poled domains or zones 91a, 91b whose direction is matched with the electric field E of the second light B2.

The quasi-phase-matching grating may also be chirped or patterned in order to compress and/or modify the shape of light pulses. The electric field E of the incoming first light B1 may be substantially parallel to the direction SX. The period Λ_{P} of the poled domains 91a, 91b may be selected in such a way that the phase of the generated second harmonic beam B2 is matched with the first (fundamental) light B1 in each poling period. Said selection is based on the dispersion of the nonlinear medium, i.e. on the difference between the refractive index of the fundamental light B1 and the second harmonic light B2.

The quasi-phase-matching grating consisting of the poled domains may also be designed to facilitate sum-frequency generation.

Λ₁ denotes the length of a zone 91a, which has been poled in a first direction (e.g. SX). Λ₂ denotes the length of a zone 91b, which has been poled in a second different direction (e.g. −SX). Adjacent zones 91a, 91b may be poled in substantially opposite directions. Λ_{P} denotes the length of a poling period. Λ_{P}=Λ₁+Λ₂. The lengths Λ_{P}, Λ₁, Λ₂ are determined in the direction of propagation of the light B1 (i.e. in the direction SZ).

The nonlinear crystal NLC may be e.g. lithium niobate, lithium tantalite, or potassium titanyl phosphate (KTiOPO₄) which is also known as the KTP, periodically poled KTP, periodically poled lithium niobate (PPLN), or lithium triborate (LBO). In particular, the nonlinear crystal NLC may be periodically poled magnesium oxide-doped lithium niobate (PP-MgO-LN). Doping with magnesium increases photoconductivity of the lithium niobate nonlinear material thus allowing lower operating temperatures of the nonlinear crystal, and still maintaining high optical damage threshold of the quasi-phase-matching grating.

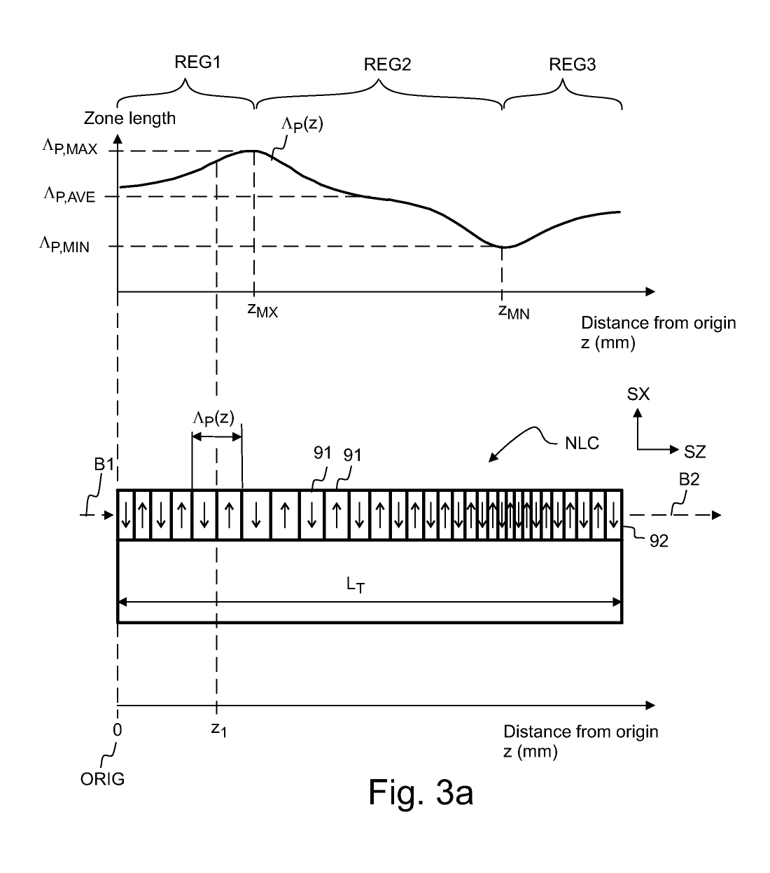

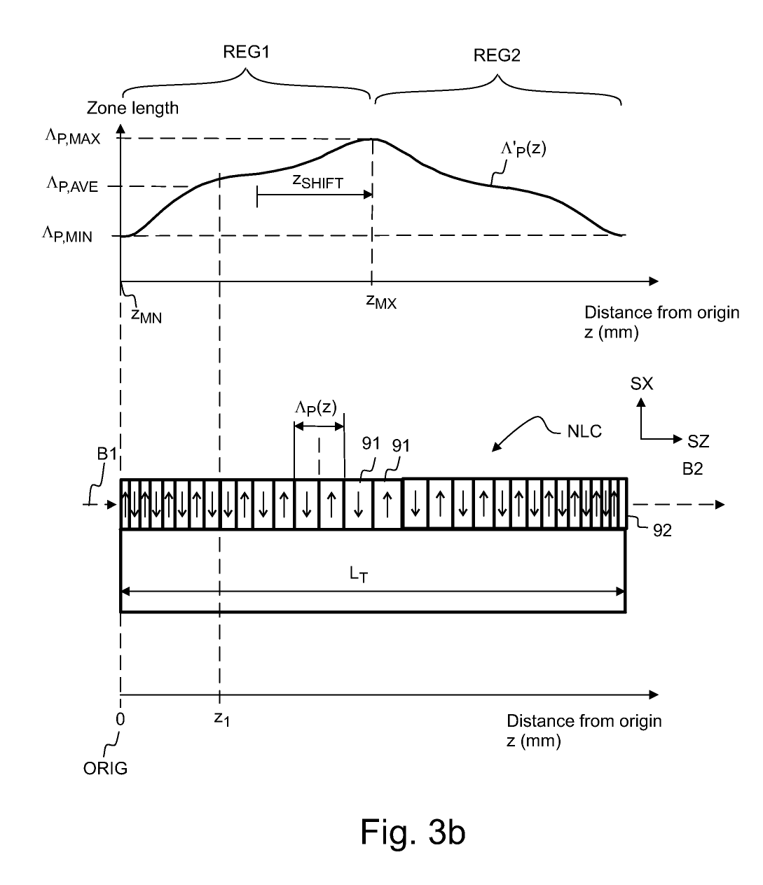

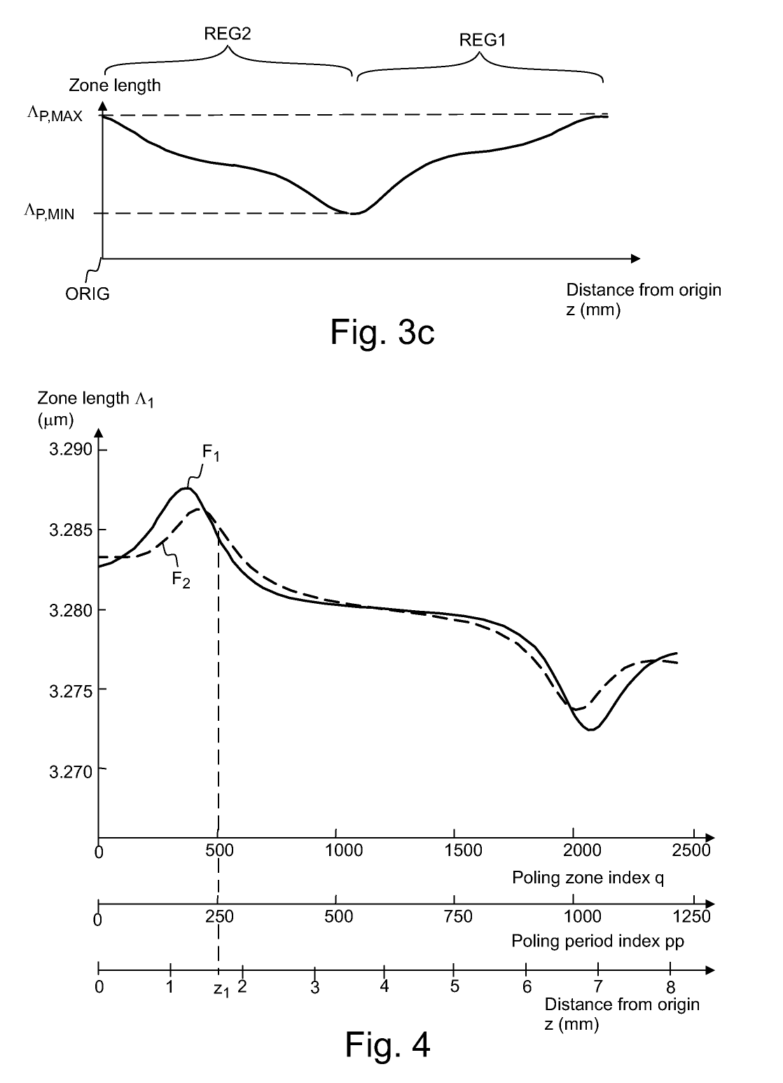

Referring to FIG. 3a, the nonlinear crystal NLC may have a first region REG1, a second region REG2 and a third region REG3. The length of the poling period Λ_{P} may increase with increasing distance z from an origin ORIG in the first region REG1 and in the third region REG3. The length of the poling period Λ_{P} may decrease with increasing distance z from the origin ORIG in the second region REG2. The second region REG2 is between the first region REG1 and the third region REG3.

The origin ORIG may coincide with an end of the nonlinear crystal NLC. The origin ORIG may coincide with the input end of the crystal NLC. Alternatively the origin ORIG may coincide with the output end of the crystal NLC.

The first light B1 may be coupled into the crystal NLC at the input end. The first light B1 may propagate in the direction SZ.

The nonlinear crystal NLC may have a first region REG1, a second region REG2 and a third region REG3. The length of the poling period Λ_{P} may decrease with increasing distance z from an origin ORIG in the first region REG1 and in the third region REG3. The length of the poling period Λ_{P} may increase with increasing distance z from the origin ORIG in the second region REG2. The second region REG2 is between the first region REG1 and the third region REG3.

The length of the first region REG1 may be e.g. greater than or equal to 5% of the total length of the crystal NLC. The length of the second region REG2 may be e.g. greater than or equal to 5% of the total length of the crystal NLC. If the crystal comprises the third region REG3, the length of the region REG3 may be e.g. greater than or equal to 5% of the total length of the crystal NLC. The length of the first region REG1 may also be e.g. greater than or equal to 20% of the total length of the crystal NLC. The length of the second region REG2 may also be e.g. greater than or equal to 20% of the total length of the crystal NLC. If the crystal comprises the third region REG3, the length of the region REG3 may be e.g. greater than or equal to 20% of the total length of the crystal NLC.

The entire length of the crystal NLC may comprise poled zones. Alternatively, substantially less than 100% of the whole length of the crystal NLC may comprise poled zones. The total length L_{T} of the poled (longitudinal) portion of the crystal NLC may be e.g. in the range of 10% to 90% of the whole length of the crystal NLC. The length of a non-poled (longitudinal) portion of the crystal NLC may be e.g. in the range of 10% to 90% of the whole length of the crystal NLC.

FIG. 3b shows an embodiment where the crystal NLC does not comprise the third period REG3.

Λ_{P,MAX} denotes the maximum length of the poling period Λ_{P}. Λ_{P,MIN} denotes the minimum length of the poling period Λ_{P}. Λ_{P,AVE} denotes the average length of the poling period Λ_{P}. z_{MX} denotes a distance z where the poling period Λ_{P} attains the maximum value Λ_{P,MAX}. z_{MN} denotes a distance z where the poling period Λ_{P} attains the minimum value Λ_{P,MIN}.

The position z_{MX} may mark the boundary between the first region REG1 and the second region REG2. The position z_{MN} may mark the boundary between the second region REG2 and the third region REG3.

The length of the poling period Λ_{P} may be expressed as a function Λ_{P}(z) of the distance z. For example, at the distance z=z₁, the length of the poling period may be equal to Λ_{P}(zᵢ)

The length of the poling period Λ_{P} may also be expressed as a function of the index of the poled zone 91 or as a function of the index of the poling period.

The total length of the nonlinear crystal NLC in the direction SZ may be substantially equal to L_{T}.

Referring to FIG. 3b, a first poling period function Λ_{P}(z) may also be shifted cyclically sideways by a length Z_{SHIFT} so as to provide a second poling period function Λ′_{P}(z), e.g. as follows:

Λ′_{P}( [symbol] )=Λ_{P}( [symbol] − [symbol] _{SHIFT}) when [symbol] − [symbol] _{SHIFT}<L_{T} (1a)

Λ′_{P}( [symbol] )=Λ_{P}( [symbol] − [symbol] _{SHIFT}−L_{T}) when [symbol] − [symbol] _{SHIFT}≧L_{T} (1b)

A nonlinear crystal NLC whose poling period is varied according to the second poling period function Λ′_{P}(z) may provide a substantially similar (even identical) conversion efficiency function Eff(λ) as a nonlinear crystal NLC whose poling period is varied according to the first poling period function Λ_{P}(z).

The poling period function Λ′_{P}(z) shown in FIG. 3b has a first region REG1 where the length of the poling period increases with increasing distance from the origin ORIG. The poling period function Λ′_{P}(z) shown in FIG. 3b has a second region REG2 where the length of the poling period decreases with increasing distance from the origin ORIG.

The curve of FIG. 3b may be formed graphically by moving the region REG3 of FIG. 3a to the left side of the region REG1 of FIG. 3a, and by shifting the curve sideways to the right (shifting by an amount z_{SHIFT}).

FIG. 3b shows a situation where the first region REG1 is closer to the origin ORIG than the second region REG2.

FIG. 3c shows a situation where the second region REG2 is closer to the origin ORIG than the first region REG1. Also in this case the length of the poling period may increase with increasing distance in the first region REG1, and the length of the poling period may decrease with increasing distance in the second region REG2. Also the curve of FIG. 3c may be obtained by shifting the curve of FIG. 3a sideways.

As mentioned above, the nonlinear crystal NLC and the poling period curve may also be flipped.

Λ″_{P}(z)=Λ_{P}(L_{T}−z) (2)

A nonlinear crystal NLC whose poling period is varied (spatially modulated) according to flipped poling period function A″_{P}(z) may provide a substantially similar (even identical) conversion efficiency function Eff(λ) as a nonlinear crystal NLC whose poling period is varied according to the first poling period function Λ_{P}(z).

The light B1 may propagate in the direction SZ or in the direction −SZ. Setting the origin ORIG at the output end of the crystal instead of setting the origin ORIG at the input end may be equivalent with flipping the poling period curve.

Flipping of the curve of FIG. 3a may provide a curve where the lengths of the poling periods decrease with increasing distance z from an origin ORIG in the first region REG1 and in the third region REG3, and where the lengths of the poling periods increase with increasing distance z from an origin ORIG in the second region REG2.

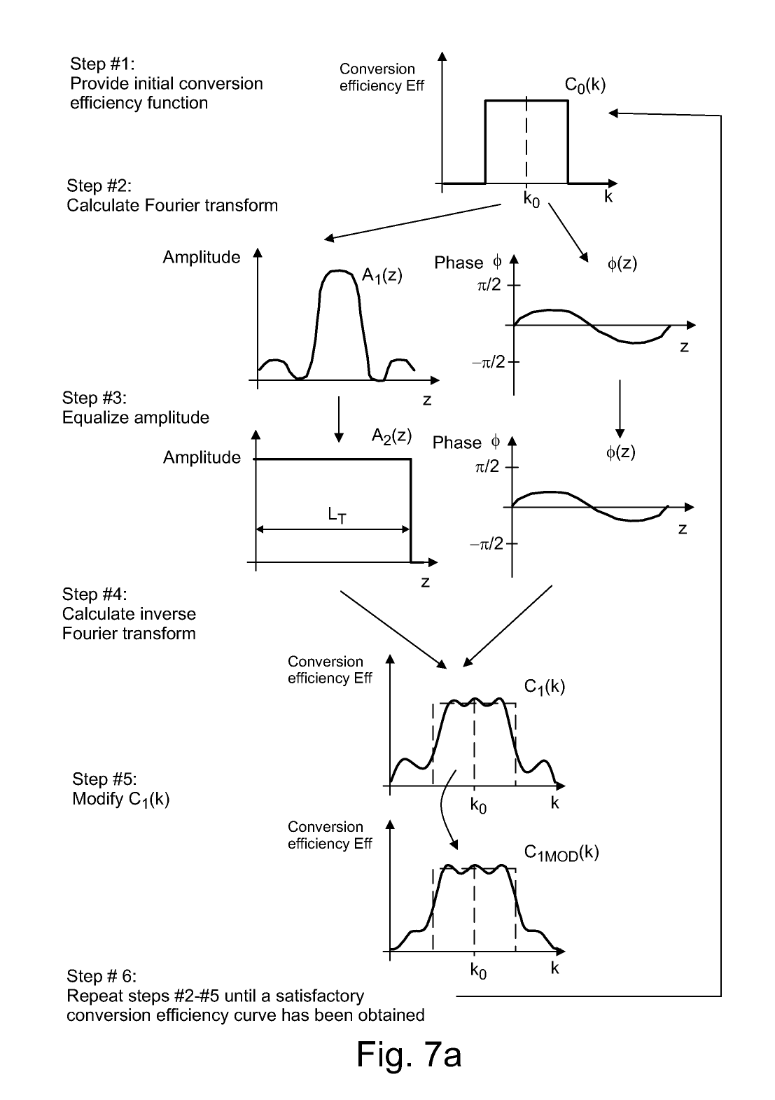

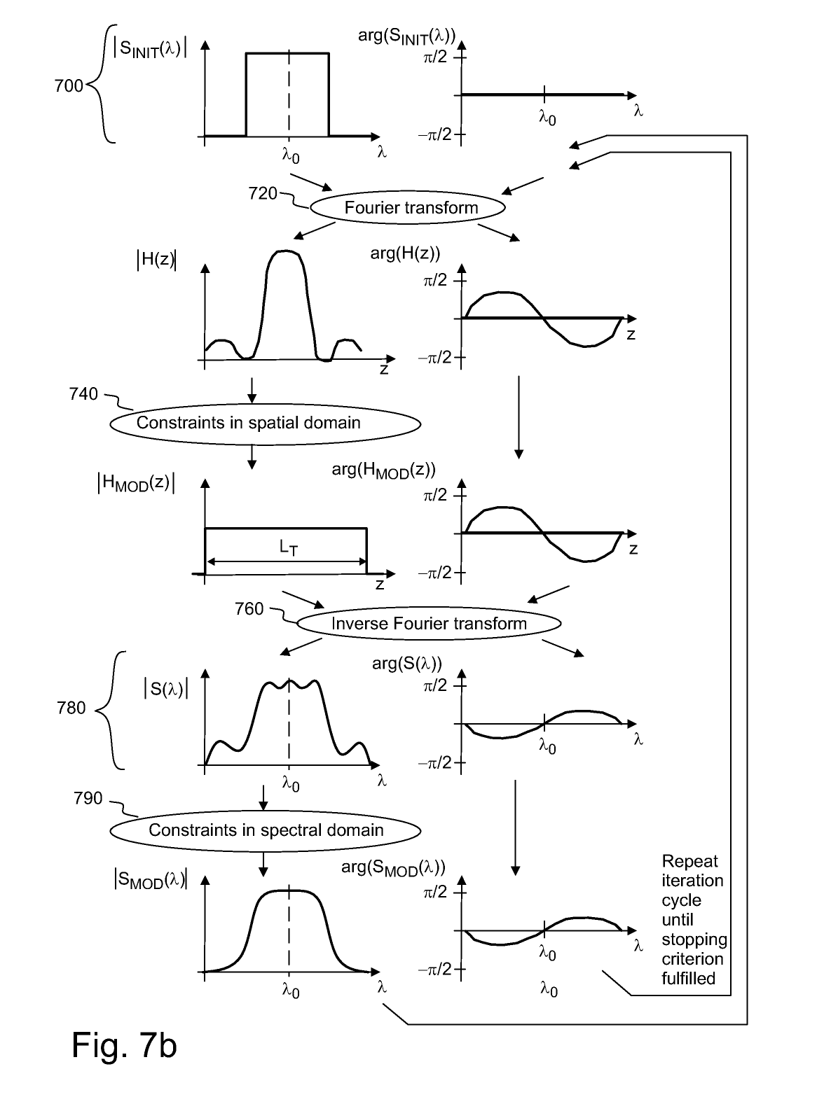

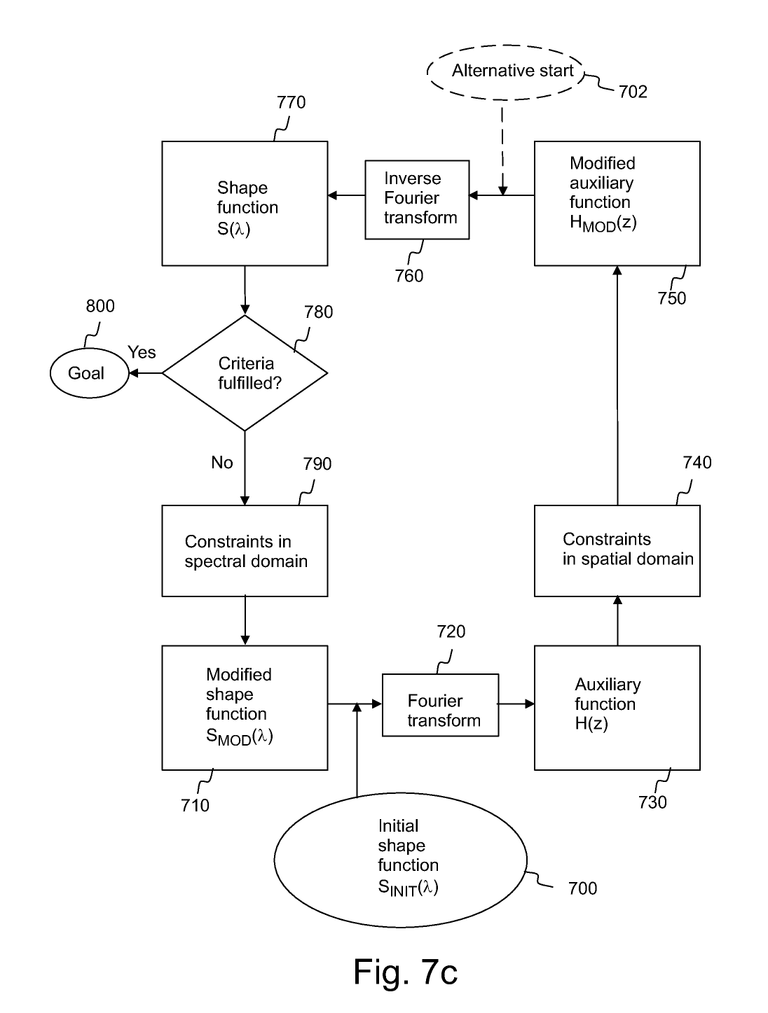

The length of the poling period may be varied (spatially modulated) according to the phase of the Fourier transform of a spectral conversion efficiency function (FIG. 7a). The length of the poling period may be varied according to a phase function which is horizontally flipped and/or which is (cyclically) shifted in the direction SZ or in the direction −SZ.

Table 1 shows, by way of example, numerical values of a poling period function Λ_{P}(z).

TABLE 1
Numerical values of a poling period function Λ_{P}(Z).

| | z (mm) | | | | | | | |
|---|---|---|---|---|---|---|---|---|
| | 0.00 | 0.12 | 0.25 | 0.38 | 0.51 | 0.64 | 0.77 | 0.91 |
| Λ_{P} (μm) | 6.5476 | 6.5473 | 6.5384 | 6.5303 | 6.5307 | 6.5386 | 6.5463 | 6.5514 |
| Δ (%) | −0.19 | −0.19 | −0.33 | −0.45 | −0.45 | −0.33 | −0.21 | −0.13 |
| | z (mm) | | | | | | | |
| | 1.04 | 1.17 | 1.30 | 1.43 | 1.56 | 1.69 | 1.83 | 1.96 |
| Λ_{P} (μm) | 6.5542 | 6.5556 | 6.5562 | 6.5562 | 6.5558 | 6.5552 | 6.5544 | 6.5536 |
| Δ (%) | −0.09 | −0.07 | −0.06 | −0.06 | −0.06 | −0.07 | −0.08 | −0.10 |
| | z (mm) | | | | | | | |
| | 2.09 | 2.22 | 2.35 | 2.48 | 2.61 | 2.74 | 2.88 | 3.01 |
| Λ_{P} (μm) | 6.5527 | 6.5521 | 6.5517 | 6.5518 | 6.5522 | 6.5529 | 6.5538 | 6.5548 |
| Δ (%) | −0.11 | −0.12 | −0.13 | −0.13 | −0.12 | −0.11 | −0.09 | −0.08 |
| | z (mm) | | | | | | | |
| | 3.14 | 3.27 | 3.40 | 3.53 | 3.66 | 3.79 | 3.93 | 4.06 |
| Λ_{P} (μm) | 6.5557 | 6.5566 | 6.5574 | 6.5581 | 6.5587 | 6.5592 | 6.5597 | 6.5602 |
| Δ (%) | −0.07 | −0.05 | −0.04 | −0.03 | −0.02 | −0.01 | 0.00 | 0.00 |
| | z (mm) | | | | | | | |
| | 4.19 | 4.32 | 4.45 | 4.58 | 4.71 | 4.85 | 4.98 | 5.11 |
| Λ_{P} (μm) | 6.5607 | 6.5613 | 6.5619 | 6.5626 | 6.5633 | 6.5642 | 6.5651 | 6.5661 |
| Δ (%) | 0.01 | 0.02 | 0.03 | 0.04 | 0.05 | 0.06 | 0.08 | 0.09 |
| | z (mm) | | | | | | | |
| | 5.24 | 5.37 | 5.50 | 5.63 | 5.76 | 5.90 | 6.03 | 6.16 |
| Λ_{P} (μm) | 6.5670 | 6.5678 | 6.5682 | 6.5683 | 6.5680 | 6.5673 | 6.5665 | 6.5657 |
| Δ (%) | 0.11 | 0.12 | 0.13 | 0.13 | 0.12 | 0.11 | 0.10 | 0.09 |
| | z (mm) | | | | | | | |
| | 6.29 | 6.42 | 6.55 | 6.68 | 6.81 | 6.95 | 7.08 | 7.21 |
| Λ_{P} (μm) | 6.5649 | 6.5642 | 6.5639 | 6.5638 | 6.5643 | 6.5656 | 6.5682 | 6.5730 |
| Δ (%) | 0.07 | 0.06 | 0.06 | 0.06 | 0.07 | 0.09 | 0.13 | 0.20 |

| | z (mm) | | | | | | | | |
|---|---|---|---|---|---|---|---|---|---|
| | 7.34 | 7.47 | 7.60 | 7.73 | 7.87 | 8.00 | 8.13 | 8.26 | 8.39 |
| Λ_{P} (μm) | 6.5806 | 6.5887 | 6.5901 | 6.5826 | 6.5735 | 6.5670 | 6.5605 | 6.5541 | 6.5476 |
| Δ (%) | 0.31 | 0.44 | 0.46 | 0.34 | 0.21 | 0.11 | 0.01 | −0.09 | −0.19 |

The lengths Λ_{P} of the poled periods of a nonlinear crystal NLC may be selected according to the table 1. Table 1 lists the lengths Λ_{P} of the poled periods as a function of distance z from the origin. Δ (%) denotes the relative deviation, i.e. Δ (%)=100%·(Λ_{P}−Λ_{P,AVE})/Λ_{P,AVE}. The poling period function Λ_{P}(z) according to Table 1 may provide a conversion efficiency function Eff(λ), whose width Δλ_{FWHM} is equal to 1.24 μm. In case of table 1, the total length of L_{T}=8.39 mm.

The input end of the crystal NLC may coincide with any of the locations z listed in table 1. For example, if the input end of the crystal coincides with z=4.06 mm, the other end of the crystal may be located at z=4.06+8.39 mm=12.45 mm. The values Λ_{P} for the distances from 4.06 mm to 12.45 mm may be obtained by shifting the values Λ_{P} from the beginning (from 0.00 mm to 3.93 mm) of the table 1 to the end of the table 1.

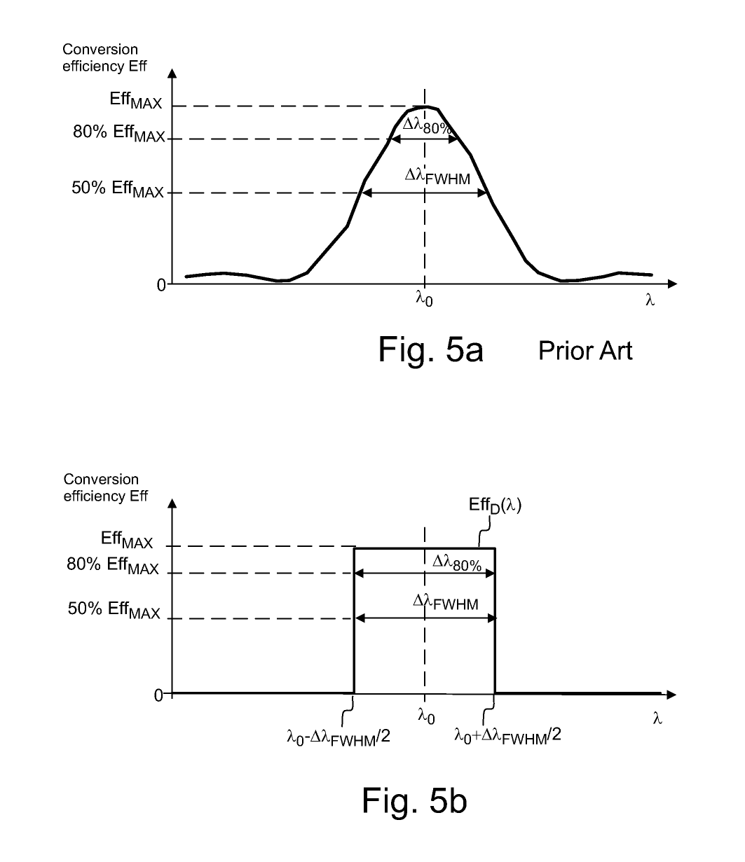

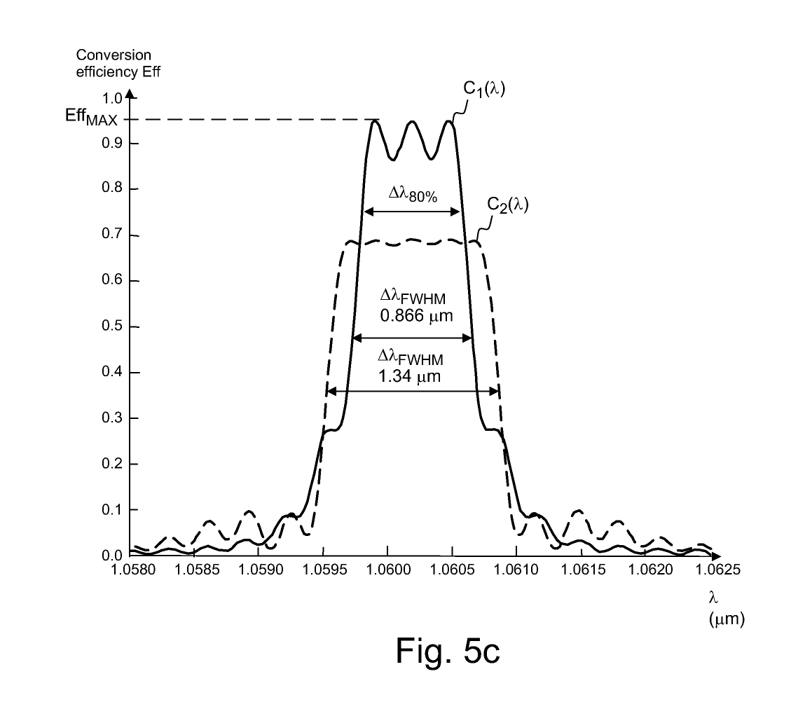

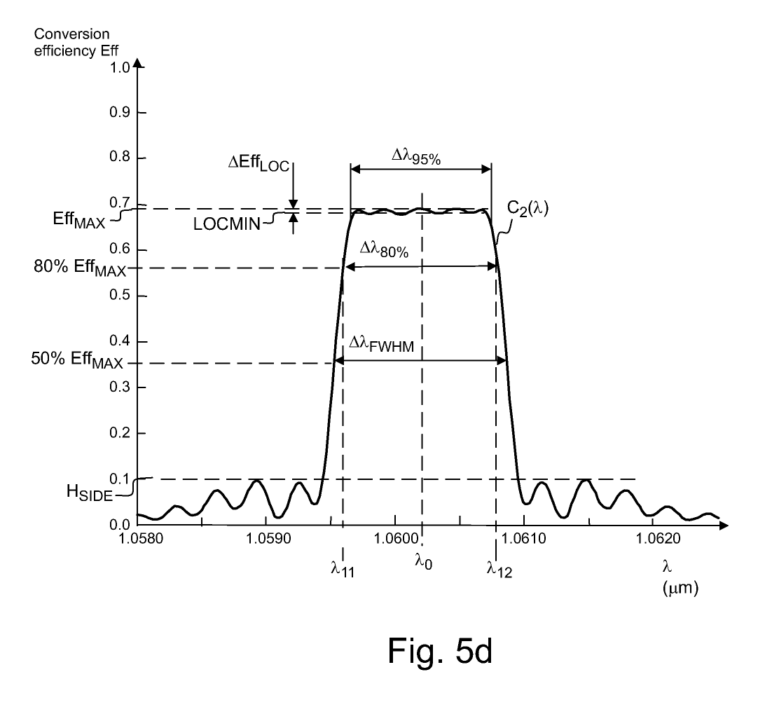

FIG. 4 shows spatial variation of the zone length Λ₁ according to a first spatial modulation function F₁ (solid line) and according to a second spatial modulation function F₂ (dashed line). The variation of the period length Λ_{P} according to the spatial modulation functions F₁ and F₂ may provide the conversion efficiency curves shown in FIG. 5c.

The modulation functions F₁ and F₂ may also be called poling period functions.

In case of FIG. 4, the length Λ_{P} of a poling period located at the position z may be substantially equal to two times the length Λ₁ of a poled zone 91 located at the position z.

The position of a poling zone or poling period may also be expressed by using the index pp of the poling period or by using the index q of the poling zone. The zones and/or the periods may be indexed (i.e. numbered) consecutively.

The poling period function F₁ or F₂ may be determined such that a start value is substantially equal to a final value, i.e. such that F₁(z=0)≈F₁(z=L_{T}).

In order to provide optimum stability, the total (poled) length of the crystal NLC may be selected to be substantially equal to the length L_{T}. The total (poled) length of the crystal NLC may be equal to the length L_{T}. However, the total length of the crystal NLC may also be shorter or longer than the length L_{T} e.g. in order to allow manufacturing tolerances or in order to use less material.

FIG. 5a shows, as a comparative example, a conversion efficiency function Eff(λ) for a crystal, which has a spatially constant poling period length Λ_{P}(z). In other words, the curve of FIG. 5a may be provided when the period length Λ_{P}(z) has the same value at all locations z inside a crystal.

Referring to FIG. 5b, an ideal conversion efficiency function Eff(λ) for many applications would be a substantially rectangular function. λ₀ denotes a central wavelength, and Δλ_{FWHM} denotes the full spectral width at half maximum. An (ideal) conversion efficiency function Eff(λ) may be substantially equal to a maximum value Eff_{MAX} when λ₀-Δλ_{FWHM}/2≦λ≦λ₀+Δλ_{FWHM}/2. The conversion efficiency function Eff(λ) may be substantially equal to zero when λ<λ₀−Δλ_{FWHM}/2 or when λ>λ₀+Δλ_{FWHM}/2.

The function of FIG. 5b may be an example of a “desired” conversion efficiency function Eff_{D}(λ).

Δλ_{80%} denotes the spectral width at a height, which is 80% of the maximum value Eff_{MAX}. In case of a rectangular function, the value Δλ_{80%} is substantially equal to the value Δλ_{FWHM}.

FIG. 5c shows conversion efficiency curves C₁, C₂ provided by the modulation functions F₁, F₂ according to FIG. 4. The spectral conversion efficiency function C₁ (solid line) corresponds to the modulation function F₁. The spectral conversion efficiency function C₂ (dashed line) corresponds to the modulation function F₂.

The wavelengths shown in FIG. 5c refer to the wavelength of the first light B1. The (spectral) conversion efficiency Eff means the fraction of instantaneous optical power of the first light B1, which is converted into the optical power of the second light B2 at a wavelength λ. Thus, the conversion efficiency can be expressed as a function of the wavelength λ. Alternatively, the spectral conversion efficiency can be expressed as a function of the optical frequency ω or as a function of the wave vector k.

It may be noticed that the width Δλ_{FWHM} and/or Δλ_{80%} may be changed by modifying the corresponding modulation function F₁.

For example, the modulation function F₁ may be selected such that the width Δλ_{FWHM} of the corresponding conversion efficiency curve C₁ is greater than or equal to 0.3 nm, greater than or equal to 0.5 nm, greater than or equal to 0.8 nm, greater than or equal to 1.0 nm, or even greater than or equal to 1.2 nm.

The curves of FIG. 5c can be interpreted to show conversion efficiency for second harmonic generation (SHG). In case of broadband light B1, a major fraction of the energy of the first light B1 is converted into second light by sum frequency generation (SFG). In principle, the conversion efficiency for SFG is a function of two variables, i.e. the wavelength of a first photon and the wavelength of a second photon. Thus, the conversion efficiency for SFG for sum frequency generation (SFG) should be represented by using a three-dimensional surface. However, the crystal NLC may nevertheless be designed by optimizing a conversion efficiency function for second harmonic generation (SHG). If the form of the conversion efficiency function for second harmonic generation (SHG) has a sufficient spectral width, it is likely that also the conversion efficiency function for sum frequency generation (SFG) has a sufficient spectral width.

FIG. 5d shows various parameters which may be used to characterize the spectral width and/or shape of a conversion efficiency function Eff(λ). The conversion efficiency function Eff(λ) of FIG. 5d may be nearly optimal for various applications. The conversion efficiency function Eff(λ) of FIG. 5d has a substantially rectangular top. In other words, the central portion of the conversion efficiency function Eff(λ) of FIG. 5d substantially resembles the rectangular function of FIG. 5b. FIG. 5d also shows further parameters characterizing the form of a conversion efficiency function Eff(λ). The conversion efficiency function Eff(λ) may have several peaks located within the width Δλ₈₀%. In that case the conversion efficiency function Eff(λ) may have one or more local depressions (i.e. local minima) between said peaks. LOCMIN denotes the minimum value of the function Eff(λ) between two peaks located within the spectral locations λ₁₁, λ₁₂. ΔEff_{LOC} denotes a difference between the maximum value Eff_{MAX} and the local minimum value LOCMIN. ΔEff_{LOC} may also be called as the depth of depression or it may be called as the magnitude of fluctuation.

In case of FIG. 5d, the fluctuations ΔEff_{LOC} in the vicinity of the central wavelength λ₀ are small (approximately 2%) when compared with the maximum value Eff_{MAX}. The ratio of the width Δλ_{95%} to the width Δλ_{FWHM} is approximately equal to 0.83. The ratio of the width Δλ_{80%} to the width Δλ_{FWHM} is approximately equal to 0.89. H_{SIDE} denotes the maximum height of sidebands. The height H_{SIDE} may be e.g. substantially equal to 14% of the maximum value Eff_{MAX}.

Δλ_{FWHM} denotes the spectral width at a height, which is half (50%) of the maximum value Eff_{MAX}. FWHM is an acronym for full width at half maximum. Δλ_{80%} denotes the spectral width at a height, which is 80% of the maximum value Eff_{MAX}. Δλ_{95%} denotes the spectral width at a height, which is 95% of the maximum value Eff_{MAX}. The conversion efficiency may reach 80% of the maximum value Eff_{MAX} at the spectral locations λ₁₁, λ₁₂. The width Δλ_{80%} is equal to the difference λ₁₂−λ₁₁.

Referring back to FIGS. 3a-4, the period length Λ_{P}(z) may be varied as a function of the location z in order to provide a conversion efficiency function Eff(λ), which has a wide and substantially flat top. In other words, the length of a poling period may depend on the location z of said period.

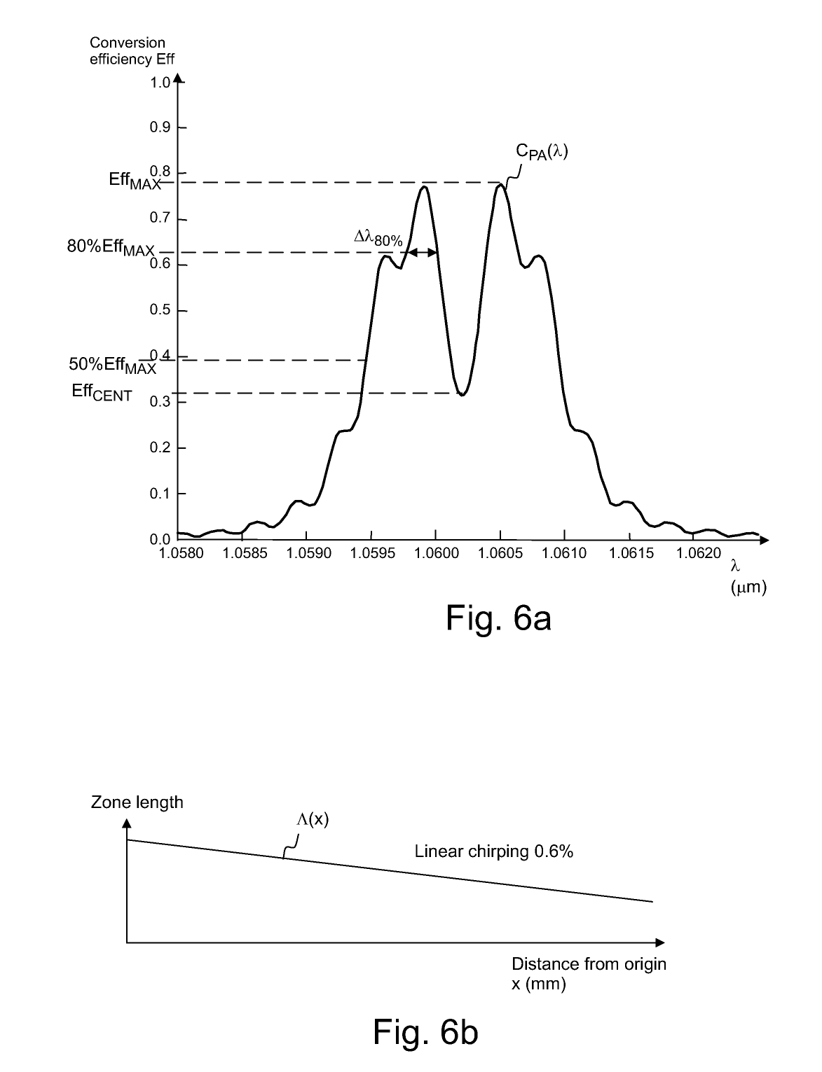

FIGS. 6a and 6b show a (comparative) example where a crystal is linearly chirped, i.e. the length of the poling period decreases linearly with increasing distance from the origin. This example shows that although the maximum value Eff_{MAX} may be rather high (78%), the central value EFF_{CENT} of the conversion efficiency may be rather low (32%). Consequently, the useful width Δλ_{80%} of the peak may be rather narrow (0.2 nm).

Thus, when using a crystal poled according to FIG. 6b, small variations in the wavelength of the first light B1 may lead to drastic variations in the optical power of the second light B2. In addition, the resulting narrow spectral width of the frequency-converted second light B2 may increase the visibility of speckle when the light B2 is viewed by human eyes.

FIG. 7a illustrates the relationship between the modulation function F₁ and the spectral conversion efficiency function C₁. FIG. 7a also illustrates how the modulation function F₁ can be determined based on a desired form of the spectral conversion efficiency function C₁.

In step #1, an initial guess for the spectral conversion efficiency function C₀ may be provided. The initial guess may be e.g. a rectangle function, which has the desired width Δλ_{FWHM} (or Δλ_{80%}).

The spectral conversion efficiency C₀ may also be expressed as a function of wavenumber k. A wavelength λ may be converted into a wavenumber k according to the following equation:

$$k = \frac{2 π}{λ} \qquad ( 3 )$$

k₀ denotes a central wavenumber corresponding to the central wavelength λ₀. The conversion efficiency Eff(λ) may be expressed as a function of the wavelength λ, or as a function of wavenumber k.

In step #2, a Fourier transform of the initial function C₀(k) may be calculated. The Fourier transform may be e.g. a discrete Fourier transform (DTF). The Fourier transform of the initial function C₀(k) has an amplitude and a phase, which may be expressed separately by using a first amplitude function A₁(z) and a phase function φ(z).

In step #3, a second amplitude function A₂(z) may be provided based on the first amplitude function A₁(z). The second amplitude function A₂(z) may have a substantially constant amplitude in the range from 0 to L_{T}. The second amplitude function A₂(z) may be substantially equal to zero when z<0 or when z>L_{T}. This corresponds to a situation where the degree of poling of the poled zones 91 is substantially equal inside the crystal NLC, and regions outside the crystal are not poled.

In step #4, a function C₁(k) may be provided by calculating an inverse Fourier transform of the amplitude function A₂(z) and the phase function φ(z). The function C₁ has a certain form. In particular, the function C₁(k) has a certain width (Δλ_{FWHM} or Δλ_{80%}) when the wavenumbers are converted into wavelengths). The inverse Fourier transform may be determined by calculating a discrete inverse Fourier transform (DFT⁻¹) from the amplitude function A₂(z) and the phase function φ(z).

In step #5, the form and/or width of the function C₁(k) may be compared with the desired form of the spectral conversion efficiency function Eff(k) or Eff(λ). If the form and/or width of the function C₁(k) is acceptable, a nonlinear crystal NLC may now be manufactured such that the length Λ_{P} of the poling periods is spatially modulated according to the phase function φ(z), which was determined in step #2.

However, if the form and/or width of the function C₁(k) is not acceptable, a modified function C_{1MOD}(k) may be provided from the function C₁(k). The modified function C_{1MOD}(k) may be provided e.g. by modifying the spectral amplitude values of the function C₁(k). The spectral amplitude values of the function C_{1MOD}(k) may be selected such that they are e.g. between the spectral amplitude values of the initial function C₀(k) and the spectral amplitude values of the function C₁(k)

In step #6, the (modified) function C_{1MOD}(k) determined in step #5 may be used as a new initial function C₀(k). The steps #2-#6 may be iteratively repeated until the form and/or width of the function C₁(k) substantially matches with the desired form and/or width of the spectral conversion efficiency function Eff(k). Repeating the steps #2-#6 (iteratively) may be called as an iterative Fourier transform algorithm (IFTA).

Principles and convergence of an iterative Fourier transform algorithm have been discussed e.g. in an article “Iterative Fourier-transform algorithm applied to computer holography, by F. Wyrowski and O. Bryngdahl, in J. Opt. Soc. Am A 5, pp. 1058-1064 (1988).

The average period length Λ_{P,AVE} may be selected according to the wavelength of the first light B1. The local period length Λ_{P}(z) may be selected such that a deviation ΔΛ_{P}(Z) from the average period length Λ_{P,AVE} at each location z is proportional to the value of the phase function φ(z).

$$\begin{matrix}{ΔΛ}_{P} ( z ) = {Λ}_{P} ( z ) - {Λ}_{P , A V E} & ( 4 ) \\ {ΔΛ}_{P} ( z ) = {coef}_{1} \cdot φ ( z ) & ( 5 ) \\ {coef}_{1} = \pm \frac{{Λ}_{P , A V E}}{2 π} & ( 6 )\end{matrix}$$

Thus, a phase shift φ(z)=π/2 may substantially correspond to a deviation of ΔΛ_{P,AVE}/4 from the average period length ΔΛ_{P,AVE}.

Smoothness of the result (i.e. smoothness of the conversion efficiency function Eff(k)) and/or convergence of the iterative algorithm may be enhanced by allowing amplitude perturbations in the second amplitude function A₂(z).

In an embodiment, a Fourier transform of the square root of the initial function C₀ may be calculated instead of calculating the Fourier transform of the initial function C₀. The result of the inverse Fourier transform may be squared, respectively. However, when C₀(k) is rectangular, both functions √C₀(k) and C₀(k) are rectangular and both have the same width.

The result of the inverse Fourier transform obtained in step #4 may be squared in order to determine whether the squared result (function) is sufficiently close to the desired conversion efficiency function.

The energy of the first light B1 is converted into the energy of the second light B2. Thus, the intensity of the first light B1 may decrease with increasing distance from the origin ORIG. In an embodiment, this effect may be taken into consideration by multiplying or dividing the amplitude function A₂(z) with a longitudinal intensity distribution function IDF(z) prior to calculating the inverse Fourier transform in step #4. In other words, the inverse Fourier transform may be calculated from the phase function φ(z) and from the amplitude function A₁(z) or A₂(z) which has been multiplied or divided by a longitudinal intensity distribution function IDF(z). The longitudinal intensity distribution function IDF(z) may be e.g. an exponentially decreasing function or a quadratic decreasing function (which can be represented by a portion of a parabola).

In an embodiment, the degree of poling may be adjusted by using poling periods which comprise four or more sub-zones poled in opposite directions. A zone 91 may now comprise two or more sub-zones poled in substantially opposite directions. The degree of poling may be controlled by selecting the ratio of the lengths of the adjacent sub-zones, which constitute the zone 91a. Consequently, the second amplitude function Λ₂(z) determined in step #3 does not need to have a constant amplitude. This may provide more freedom to select the period length function Λ_{P}(z) so that an optimum conversion efficiency curve Eff(λ) can be obtained.

Also FIGS. 7b and 7c illustrate determining a suitable period length function Λ_{P}(z) by an iterative Fourier Transform algorithm (IFTA). The iterative Fourier Transform algorithm (IFTA) may be understood to be carried out by using a complex-valued shape function S(λ) and a complex-valued auxiliary function H(z).

When the algorithm converges to a solution, the auxiliary function H(z) may be equal to a Fourier transform of the shape function S(λ). The shape function S(λ) may be equal to the inverse Fourier transform of the auxiliary function H(z). When the algorithm converges, the shape function S(λ) and the auxiliary function H(z) may form a Fourier transform pair.

The amplitude |H(z)| of the auxiliary function H(z) may be equal to the amplitude A₁(z) shown in FIG. 7a, and the phase arg(H(z)) of the auxiliary function H(z) may be equal to the phase function φ(z). In other words, φ(z)=arg(H(z)). The phase function φ(z) also appears in FIG. 7a and in the equation (5).

The iterative Fourier Transform algorithm (IFTA) may also comprise using a modified auxiliary function H_{MOD}(z). The amplitude |H_{MOD}(z)| of the modified auxiliary function H_{MOD}(z) may be equal to the amplitude A₂(z) shown in FIG. 7a. The phase of the modified auxiliary function arg(H_{MOD}(z)) may be equal to the phase arg(H(z)).

The iterative Fourier Transform algorithm (IFTA) may also comprise using a modified shape function S_{MOD}(λ).

The auxiliary function H(z) may be equal to a Fourier transform of the modified shape function S_{MOD}(λ). The shape function S(λ) may be equal to the inverse Fourier transform of the modified auxiliary function H_{MOD}(z).

In step 700, the algorithm may be started by taking an initial guess S_{INIT}(λ) for the shape function S(λ). If the desired conversion efficiency function Eff_{D}(λ) is known at least approximately, the initial guess S_{INIT}(λ) may be set to be identical to the desired conversion efficiency function Eff_{D}(λ).

FIG. 5b shows, by way of example, a desired conversion efficiency function Eff_{D}(λ) having a substantially rectangular spectral shape. Thus, the amplitude |S_{INIT}(λ)| of the initial guess function S_{INIT}(λ) may be set to a constant (real) value when λ₀−Δλ_{FWHM}/2≦λ≦λ₀+Δλ_{FWHM}/2, and the amplitude |S_{INIT}(λ)| may be equal to zero when λ<λ₀−Δλ_{FWHM}/2 or when λ>λ₀+Δλ_{FWHM}/2.

In step 720, the auxiliary function H(z) may be determined by calculating the Fourier transform of the initial shape function S_{INIT}(λ). The first estimate for the poling period function Λ_{P}(z) may be proportional to the phase arg(H(z)). In particular, the first estimate for the poling period function Λ_{P}(z) may be calculated from the phase arg(H(z)) of the auxiliary function H(z) by using equation (5), and by using the relationship φ(z)=arg(H(z)).

However, the first estimate for the poling period function Λ_{P}(z) may correspond to a poled crystal NLC, which is difficult or impossible to produce in practice. The iteration algorithm may comprise a modification step 740 where relevant spatial constraints may be taken into account. In step 740, a modified auxiliary function H_{MOD}(z) may be determined from the auxiliary function H(z).

The modified auxiliary function H_{MOD}(z) may be determined from the auxiliary function H(z) such that manufacturing of the crystal NLC of the crystal becomes possible.

The modified auxiliary function H_{MOD}(z) may be determined from the auxiliary function H(z) such that manufacturing of the crystal NLC of the crystal becomes easier.

For example, it may be easiest to manufacture a crystal NLC where the degree of poling of the poled zones does not depend on the distance z from the origin. In other words, the magnitude of poling may be spatially constant inside the crystal NLC.

Thus, for example, the amplitude |H_{MOD}(z)| of the modified auxiliary function H_{MOD}(z) may be set to a constant value within the crystal NLC (i.e. when 0≦z≦L_{T}), and the amplitude |H(z)| may be set to zero outside the crystal NLC. The modified auxiliary function H_{MOD}(z) obtained in the modification step 740 may have substantially the same phase as the auxiliary function H(z). In other words the phase function arg(H_{MOD}(z)) may be equal to the phase function arg(H(z)) obtained after the Fourier transform step 720.

In step 760, a new candidate for the shape function S(λ) may be determined by calculating an inverse Fourier transform of the modified auxiliary function H_{MOD}(Z).

The shape function S(λ) obtained by step 760 may be evaluated in the step 780. In particular, the amplitude |S(λ)| of the shape function S(λ) may be compared with the desired conversion efficiency function Eff_{D}(z).

If the stopping criterion is fulfilled, the algorithm may be stopped in the step 800.

If the stopping criterion is not fulfilled, a modified shape function S_{MOD}(λ) may be determined from the shape function S(λ) in step 790. In particular, the amplitude of the shape function S(z) may be adjusted so as to form the modified shape function S_{MOD}(z).

The amplitude |S_{MOD}(λ)| of the modified shape function S_{MOD}(λ) may be set to be substantially equal to the initial amplitude |S_{INIT}(λ)|, wherein the phase arg(S_{MOD}(λ)) of the modified shape function S_{MOD}(λ) may be set to be substantially equal to the phase arg(S(λ)) of the shape function S(λ)) obtained in the inverse Fourier transform step 760. The modified shape function S_{MOD}(λ) may have substantially the same phase as the shape function S(λ). In other words, arg(S_{MOD}(λ)) may be equal to arg(S(λ)).

After the modification step 790, the amplitude |S_{MOD}(λ)| of the modified shape function S_{MOD}(λ) may substantially correspond to the desired conversion efficiency function Eff_{D}(λ).

Now, the modified shape function S_{MOD}(λ) may be used as input for the next iteration cycle of the iterative Fourier Transform algorithm (IFTA). The modified shape function S_{MOD}(λ) may be used as input for the Fourier transform step 720 instead of the seed function S_{INIT}(λ) which was used as the input in the first iteration cycle of the algorithm.

Fourier transform of the modified shape function S_{MOD}(λ) in step 720 provides a new auxiliary function H(λ). A new candidate for the poling period function Λ_{P}(z) may be calculated from the phase arg(H(λ)) of the new auxiliary function S(λ) by using the equation (5).

An iteration cycle comprising the transform step 720, the modification step 740, the transform step 760, the evaluation step 780 and the modification step 780 may be repeated in successive order until a stopping criterion is fulfilled.

The poling period function Λ_{P}(z) obtained after the transform step 760 may be evaluated in step 780 by checking one or more criteria. If the stopping criterion is fulfilled, the algorithm may be stopped in step 800. If the criterion is not fulfilled, the algorithm may be continued with a new iteration cycle.

For example, the steps 790, 720, 740, 760, 780 may be repeated until the width Δλ_{80%} of a conversion efficiency function Eff(λ) corresponding to the amplitude of the shape function S(λ) obtained in step 760 is greater than a predetermined value and/or until the depth of depression ΔEff_{LOC} (FIG. 5d) of the conversion efficiency function Eff(λ) corresponding to the amplitude of the shape function S(λ) is smaller than a predetermined value.

For example, the ratio Δλ_{80%}/Δλ_{FWHM} may be compared with a reference value in step 780. The iteration may be stopped when the ratio Δλ_{80%}/Δλ_{FWHM} is greater than or equal to a predetermined value.

The magnitude of adjustments made in steps 740 and 790 may be limited such that the algorithm converges to a solution.

Convergence of the iterative algorithm IFTA may be enhanced by allowing small perturbations in the amplitude |S(λ)|.

The modifications made in steps 740 and 790 may be gradual so as to ensure convergence of the algorithm.

The solving of a feasible and/or satisfactory poling period function Λ_{P}(z) may require repeating the iteration cycle two or more times. For example, 10 to 1000 iteration cycles may be carried out until the selected criteria are fulfilled. A single iteration cycle may comprise a Fourier transform step 720, an inverse Fourier transform step, and at least one of the modification steps 740, 790.

The algorithm may also be started e.g. by taking an initial guess for the auxiliary function H(z) in step 702.

Alternatively, in the transform step 720, an inverse Fourier transform may be calculated instead of calculating the Fourier transform, and in the transform step 760, a Fourier transform may be calculated instead of calculating the inverse Fourier transform.

In practice, the Fourier transform may be determined by calculating a Discrete Fourier Transform (DTF). The inverse Fourier transform may be determined by calculating a Discrete Inverse Fourier transform (DFT⁻¹).

In step 730, an auxiliary function H(z) obtained after the Fourier transform step 720 may be stored in a memory. In step 750, a modified auxiliary function H_{MOD}(z) may be stored in a memory. In step 770, a shape function S(λ) obtained after the inverse Fourier transform step 760 may be stored in a memory. In step 710, a modified shape function S_{MOD}(λ) may be stored in a memory.

As the result, the iterative Fourier transform algorithm may provide a phase function φ(z)=arg(H(z)), which allows calculation of the poling period function Λ_{P}(z) according to the equation (5).

As the result, the iterative Fourier transform algorithm may provide an auxiliary function H(z) such that the amplitude of the inverse Fourier transform of the auxiliary function H(z) substantially corresponds to the desired conversion efficiency function Eff_{D}(λ).

As the result, the iterative Fourier transform algorithm may provide the phase arg(H(z)) such that crystal NLC implemented according to equation (5) provides a conversion efficiency function Eff(λ), which substantially matches with the desired conversion efficiency function Eff_{D}(λ).

As the result, a conversion efficiency function Eff(λ) provided by the crystal NLC may fulfill one or more of the following conditions:

The width Δλ_{FWHM} of the conversion efficiency Eff(λ) may be e.g. greater than or equal to 0.3 nm, advantageously greater than or equal to 0.5 nm, preferably greater than or equal to 0.8 nm. Yet, the width Δλ_{FWHM} may be greater than or equal to 1.0 nm or even greater than or equal to 1.2 nm.

The width Δλ_{80%} of the conversion efficiency Eff(λ) may be e.g. greater than the width multiplied by 0.6. Advantageously, the width Δλ80% is greater than the width multiplied by 0.7. Preferably, the width Δλ80% is greater than the width multiplied by 0.8.

The width Δλ₉₅% of the conversion efficiency Eff(λ) may be e.g. greater than the width multiplied by 0.6. Advantageously, the width Δλ80% is greater than the width multiplied by 0.7. Preferably, the width Δλ80% is greater than the width multiplied by 0.8.

The fluctuations ΔEff_{LOC} in the vicinity of the central wavelength λ₀ may be e.g. smaller than 10% of the maximum value Eff_{MAX}. Advantageously, the fluctuations ΔEff_{LOC} in the vicinity of the central wavelength λ₀ are smaller than 5% of the maximum value Eff_{MAX}. Preferably, fluctuations ΔEff_{LOC} in the vicinity of the central wavelength λ₀ are smaller than 3% of the maximum value Eff_{MAX}.

One or more of the conditions mentioned above may be used as a stopping criterion in the evaluation step 780 of the algorithm IFTA.

When the algorithm IFTA has converged, the poling period function Λ_{P}(z) of the crystal NLC may substantially correspond to the phase arg(H(z)) of an auxiliary function H(z), wherein the auxiliary function (H(z)) may be obtained by calculating a Fourier transform of the conversion efficiency function (EFF(λ)) of the crystal NLC.

The poling period function Λ_{P}(z) of the crystal NLC may substantially correspond to the phase arg(H(z)) of an auxiliary function H(z), wherein the auxiliary function (H(z)) may be determined such that the conversion efficiency function (EFF(λ)) is substantially equal to the amplitude of the inverse Fourier transform of the auxiliary function (H(z)).

The poling period function Λ_{P}(z) of the crystal NLC may substantially correspond to the phase arg(H(z)) of an auxiliary function H(z), wherein the auxiliary function (H(z)) may be obtained by calculating a Fourier transform of a shape function (S(λ)), which corresponds to the conversion efficiency function (EFF(λ)) of the crystal NLC.

The poling period function Λ_{P}(z) of the crystal NLC may substantially correspond to the phase arg(H(z)) of an auxiliary function H(z), wherein the auxiliary function (H(z)) may be determined such that the conversion efficiency function (EFF(λ)) substantially corresponds to a function |S(λ)|, which is equal to the amplitude of the inverse Fourier transform of the auxiliary function (H(z)).

The locally averaged poling period function Δ_{P,LA}(z) of the crystal NLC may substantially correspond to the phase arg(H(z)) of an auxiliary function H(z), wherein the auxiliary function (H(z)) may be obtained by calculating a Fourier transform of a shape function S(λ), which corresponds to the conversion efficiency function EFF(λ).

The locally averaged poling period function Λ_{P,LA}(z) of the crystal NLC may substantially correspond to the phase arg(H(z)) of an auxiliary function arg(H(z), wherein the auxiliary function H(z) may be determined such that the conversion efficiency function EFF(λ) substantially corresponds to a function |S(λ)|, which is equal to the amplitude of the inverse Fourier transform of the auxiliary function H(z).

The conversion efficiency may be proportional to the square of the intensity of light B1 propagating in the crystal. In an embodiment, the square root √Eff_{D}(λ) of the desired conversion efficiency function may be used as the initial shape function S_{INIT}(λ) in step 700. The transform step 760 may provide a shape function, and the squared amplitude |S(λ)|² of the shape function may be compared with the desired conversion efficiency function Eff_{D}(λ) in order to determine whether the conversion efficiency function Eff(λ) provided by the crystal NLC substantially matches with the desired conversion efficiency function Eff_{D}(λ).

When the algorithm IFTA has converged, the locally averaged poling period function Λ_{P,LA}(Z) of the crystal NLC may substantially correspond to the phase arg(H(z)) of an auxiliary function arg(H(z)), and wherein the auxiliary function H(z) may be obtained by calculating a Fourier transform of the square root of the conversion efficiency function EFF(λ).

The locally averaged poling period function Λ_{P,LA}(z) of the crystal NLC may substantially correspond to the phase arg(H(z) of an auxiliary function H(z), wherein the auxiliary function (H(z)) may be determined such that the conversion efficiency function EFF(λ) is substantially proportional to a function |S(λ)|², which is equal to the square of the amplitude of the inverse Fourier transform of the auxiliary function H(z).

However, when the desired conversion efficiency function Eff_{D}(λ) has a substantially rectangular shape, the square root √Eff_{D}(λ) also has a substantially rectangular shape. In case of the rectangular function Eff_{D}(λ), a first poling period function Λ_{P}(z) obtained by setting S_{INIT}(λ)=√Eff_{D}(λ) may be substantially similar (or even identical) when compared to a second poling period function obtained by setting S_{INIT}(λ)=Eff_{D}(λ).

The intensity of light B1 propagating in the crystal NLC may decrease with increasing distance z from the origin ORIG. The decreasing intensity may be taken into consideration by using a correcting function u(z). In the modifying step 740, the amplitude of the modified auxiliary function |H_{MOD}(z)| may be set to be equal to the function u(z). For example, the function u(z) may be substantially equal to a linear function, i.e. u(z)=v₁+v₂·z, where v₁ and v₂ are constants. For example, the function u(z) may be substantially equal to an exponential function, i.e. u(z)=v₃·e^{t·z}, where v₃ and t are constants. For example, the function u(z) may be substantially equal to the combination of the linear function and the exponential function, i.e. u(z)=v₁+v₂·z+v₃·e^{t·z}.

The modification may also be gradual, i.e. the function u(z) may be equal to v₁+v₂·z+e^{t·z}+v₄·|H(z)|, where v₄ is in the range of 0 to 1, and H(z) is the auxiliary function obtained by the transform step 720.

A suitable function u(z) may also be determined by numerical optimization. For example, a suitable function u(z) may be found by determining a first poling period function Λ_{P}(z) by using a first candidate function u(z) in the iterative Fourier transform algorithm, and by determining a second poling period function Λ_{P}(z) by using a second candidate function u(z) in the iterative Fourier transform algorithm. Now, it may be experimentally or theoretically tested whether the use of said first candidate function u(z) or the second candidate function u(z) provides a closer match with the desired conversion efficiency curve and the attained conversion efficiency curve.

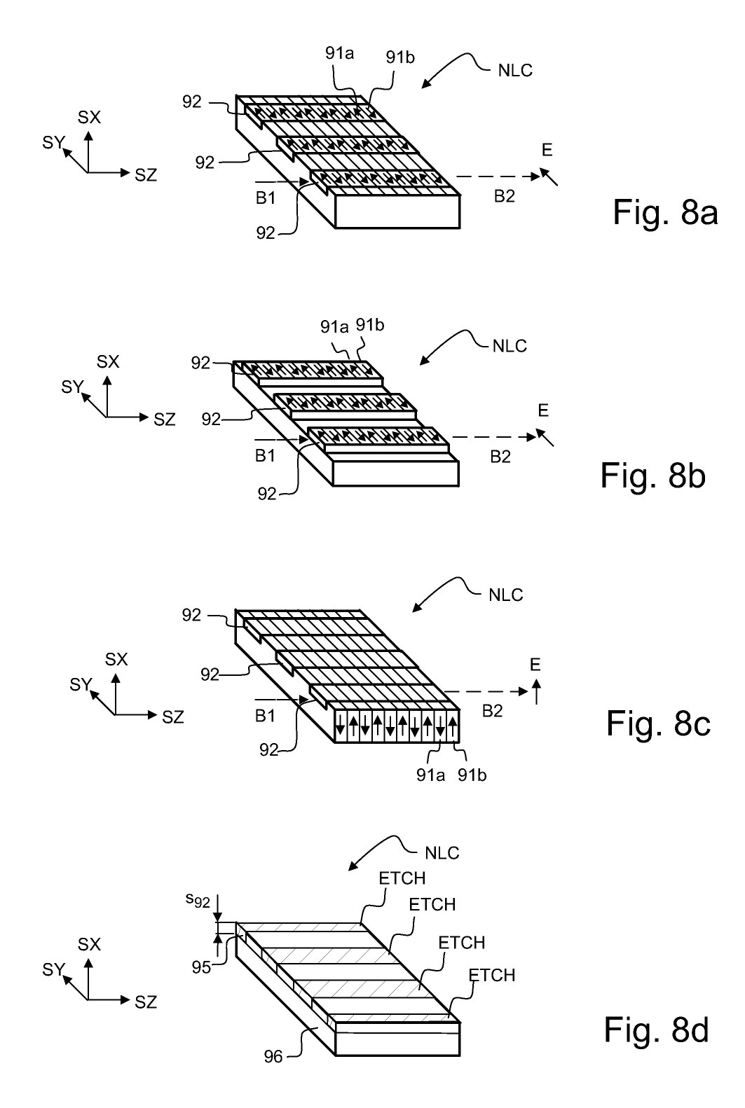

Referring to FIG. 8a, the nonlinear crystal NLC may comprise one or more waveguides 92 for guiding the first light B1. The waveguides 92 comprise nonlinear medium. The purpose of the waveguides is to preserve a high intensity along the length of crystal NLC, i.e. in the direction SZ, for more efficient conversion.

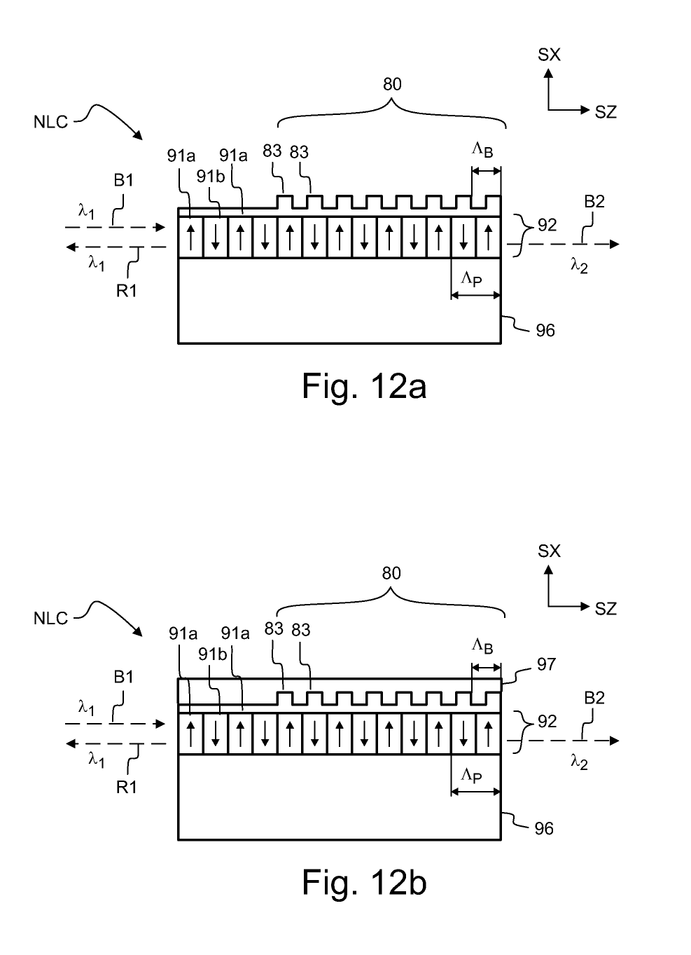

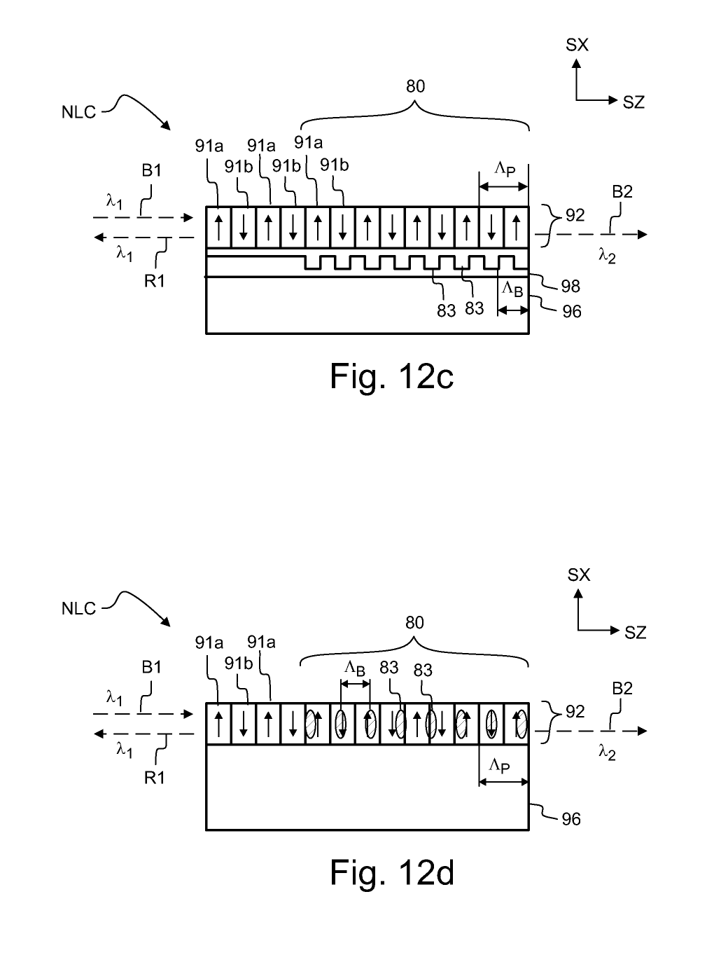

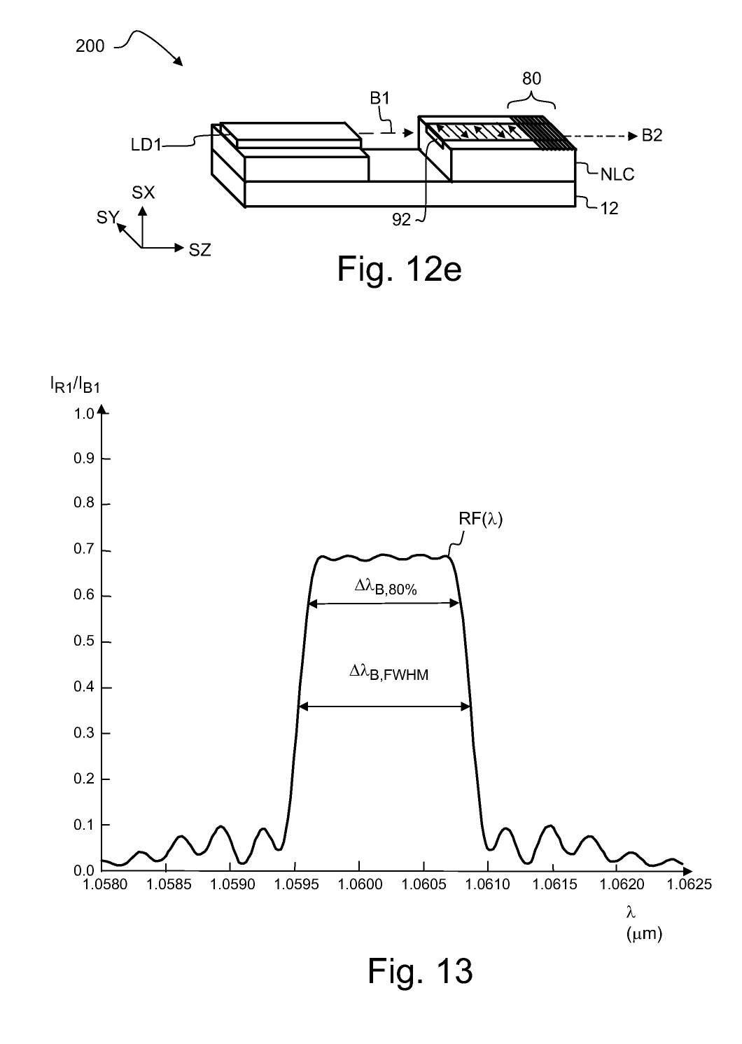

Implementation of a Bragg grating 80 (see e.g. FIG. 12a) on/in a waveguide 92 may also be more feasible than implementation of a Bragg grating 80 in a bulk type nonlinear crystal NLC, especially with certain nonlinear materials such as lithium niobate, due to limited transparency of the nonlinear material. Thanks to the waveguide 92, the conversion efficiency per unit length of the nonlinear material may be increased so that a shorter interaction length may be used.

The waveguides 92 may be implemented on the side of the nonlinear crystal NLC e.g. by annealed-proton-exchange (APE) or by diffusion, e.g. by zinc or titanium diffusion.

The crystal NLC may have one or more waveguides 92. The waveguides 92 may be formed on one or both sides of the nonlinear crystal NLC (In FIG. 8a, three waveguides have been formed on the same side).

A single nonlinear crystal NLC may have several periodically poled zones whose periods are optimized for several different fundamental frequencies. Thus, a single nonlinear crystal NLC may be adapted to provide e.g. red, green and blue light.

FIG. 8a shows three waveguides 92 embedded in the crystal. The space between the waveguides 92 may be substantially filled such that the surface adjacent to the waveguides 92 is smooth. The waveguides 92 may comprise the poled zones 91a, 91b. The surface adjacent to the waveguides 92 may be parallel to a plane defined by the directions SZ and SY. The zones 91a, 91b may be poled along the surface of the crystal NLC in the direction SY and in the direction −SY.

Referring to FIG. 8b, the waveguides 92 may be ridge waveguides. The ridge waveguides may be implemented e.g. by etching.

Referring to FIG. 8c, the zones 91a, 91b may be poled in the direction SX and in the direction −SX. In other words, the crystal NLC may be poled in a direction, which is substantially perpendicular to the outer surface adjacent to the waveguide 92.

A nonlinear crystal NLC may also be implemented without a waveguide 92.

A Bragg grating may be implemented on a waveguide 92 (FIG. 12a, FIG. 12b), inside a waveguide 92 (FIG. 12d), or under a waveguide 92 (FIG. 12c). The Bragg grating may be protected by a covering layer.

Referring to FIG. 8d, a waveguiding ridge may be formed e.g. by changing the refractive index of a surface layer 95 of a substrate 96 in order to form a substantially planar waveguide, and by etching material away from regions ETCH so as to form one or more ridges. The refractive index of a surface layer 95 of a substrate 96 may be changed e.g. by proton exchanging. s₉₂ denotes the thickness of the surface layer 95.

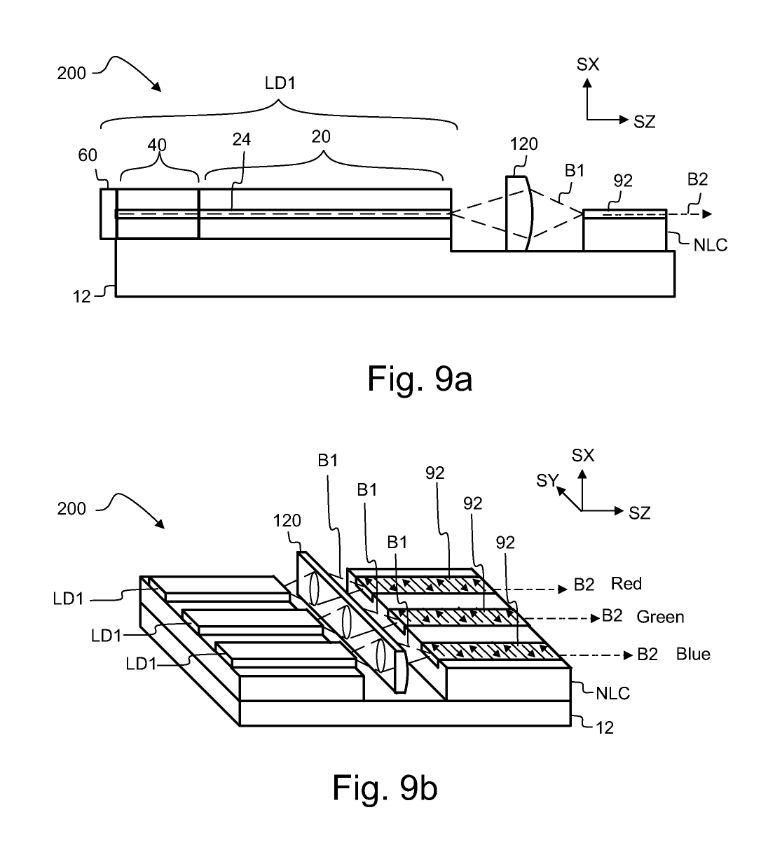

Referring to FIG. 9a, a light source 200 may comprise a light emitting unit LD1 and a nonlinear crystal NLC. A light concentrating structure 120 may be arranged to concentrate the first light B1 provided by the light emitting unit LD1 into the nonlinear crystal NLC. The light emitting unit LD1 and the nonlinear crystal NLC may be mounted on a base plate 12. Also the light concentrating structure 120 may be attached to the base plate 12 directly or by using a suitable spacer.

The light emitting unit LD1 may comprise a gain region 20 and a saturable optical absorber 40 arranged to provide pulsed light B1. Pulsing of the light B1 may increase the peak intensity of the first light B1 in the crystal NLC, thereby increasing the conversion efficiency Eff. Pulsing of the light B1 may also reduce coherence of the light beam B2, thereby reducing visually annoying speckle patterns.

The light B1 may be generated in a waveguide 24. The gain region 20 may comprise the waveguide 24. A reflector 60 may be arranged to reflect light back to the waveguide 24.

The light concentrating structure 120 may be e.g. a refractive or diffractive lens.

FIG. 9b shows, in a three dimensional view, a light source 200 comprising three light emitting units LD1 and a nonlinear crystal NLC comprising three waveguides 92. The light emitting units LD1 may provide first light B1 having the same color or different colors. The light source 200 may substantially simultaneously provide red, green and blue light. The light source 200 may be an RGB light source.

If the distance between the light emitting unit LD1 and the crystal NLC is small enough, the light B1 may also be directly coupled from the unit LD1 into the crystal NLC, i.e. it is not necessary use a coupling structure 120 (e.g. a focusing lens).

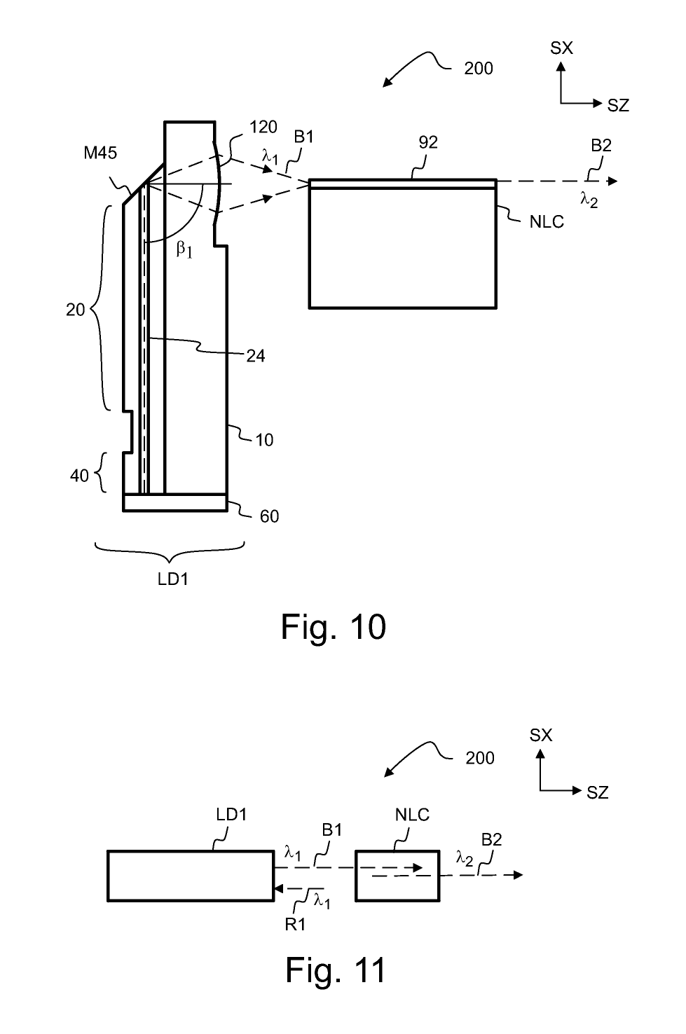

Referring to FIG. 10, the light source 200 may comprise a beam directing structure M45, which is arranged to change the direction of the first light B1 emitted from the gain region 20. The direction of the first light B1 may be changed by an angle β1, which is in the range of 70 to 110 degrees. The folded arrangement of FIG. 10 may provide a more compact structure, a more stable structure and easier alignment of the optical components than the linear arrangement of FIG. 9a. In particular, the light concentrating structure 120 may be implemented on the substrate 10 of the light emitting unit LD1. The common substrate 10 may be of a substantially transparent semiconductor material, e.g. gallium arsenide (GaAs), gallium indium arsenide (GaInAs) or Indium phosphide (InP).

Referring to FIG. 11, the light source 200 may comprise a spectrally selective component, which is arranged to provide optical feedback R1 to the gain region 20 of the light emitting unit LD1. For example, the nonlinear crystal NLC may comprise a spectrally selective component arranged to provide optical feedback R1 to the gain region.

The optical feedback R1 may used stabilize the wavelength of the first light B1 and/or to modify the temporal shape of light pulses provided by the light emitting unit LD1.

Referring to FIG. 12a, the spectrally selective component may be a (Bragg) grating, which is implemented on the crystal NLC. The Bragg grating 80 may be implemented e.g. by etching. The waveguide 92 may be implemented on a substrate 96.

Referring to FIG. 12b, the Bragg grating may be covered with a protective layer 97.

Referring to FIG. 12c, the Bragg grating may be implemented under the waveguide 92. The Bragg grating may be located between the waveguide 92 and a substrate 96. A space between the Bragg grating and a substrate 96 may be filled with a filler material 98.

The Bragg grating 80 may be formed on a waveguide layer 92, and the Bragg grating may be subsequently attached (sandwiched/stacked) to a substrate 96.

Alternatively, the Bragg grating 80 may be formed on a substrate 96, and the Bragg grating 80 may be subsequently attached (sandwiched/stacked) to a waveguide layer 92.

Referring to FIG. 12d, the Bragg grating may be implemented in the waveguiding layer 92 e.g. by forming diffractive features 83 inside the waveguide 92 e.g. by using a high power laser beam. In other words, laser scribing may be used.

The Bragg grating 80 may be implemented on the side of the waveguide 92 (FIG. 12a, FIG. 12b, FIG. 12c) or in the waveguide 92 (FIG. 12d). The Bragg grating 80 may have a plurality of diffractive features 83 having a period Λ_{B}. The diffractive features 83 may be e.g. ridges or grooves.

The waveguide 92 may comprise a cladding layer which has a lower refractive index than a core of said waveguide 92. The Bragg grating 80 may be implemented on said cladding. The distance between the core of said waveguide 92 and the diffractive features 83 of the Bragg grating 80 may be selected such that that the reflectivity of the Bragg grating 80 is substantially higher for the first light pulses B1 than for the second light pulses B2.

FIG. 12e shows a light source 200 comprising a light emitting unit LD1 nonlinear crystal NLC, which in turn comprises a grating 80 to provide optical feedback R1 to the light emitting unit LD1.

Referring to FIG. 13, the spectrally selective feedback component (e.g. Bragg grating 80) has a spectral reflectance function RF(λ). The spectral reflectance function RF(λ) may also be marked as I_{R1}(λ)/I_{B1}(λ), where I_{B1}(λ) denotes the spectral intensity of the first light B1, and I_{R1}(λ) denotes the spectral intensity of the reflected light R1. The spectral reflectance function I_{R1}(λ)/I_{B1}(λ) may have a width Δλ_{B,FWHM}, and a width Δλ_{B,80%}. Δλ_{B,FWHM} denotes full width at half maximum and Δλ_{B,80%} denotes full width at 80% of the maximum.

The width Δλ_{B,FWHM} of the spectral reflectance function RF(λ) may be greater than or equal to the width Δλ_{FWHM} of the spectral conversion efficiency function (FIG. 5c). The width Δλ_{B,80%} of the spectral reflectance function RF(λ) may be greater than or equal to the width Δλ_{80%} of the spectral conversion efficiency function (FIG. 5c).

When the width of the spectral reflectance function is selected to be greater than or equal to the width of the conversion efficiency function, this may provide relatively stable operation also in a situation where the operating temperature of the nonlinear crystal NLC deviates from an optimum (predetermined) operating temperature of the nonlinear crystal NLC.

When the nonlinear crystal NLC comprises the Bragg grating, this may provide improved stability, because the Bragg grating may expand substantially at the same rate as the nonlinear material of the crystal NLC.

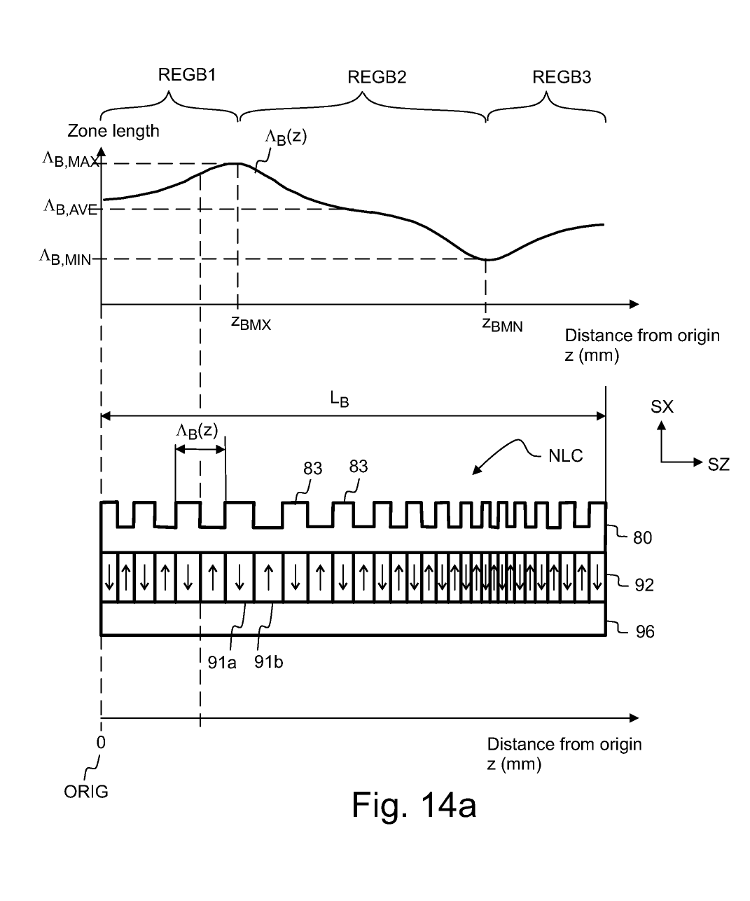

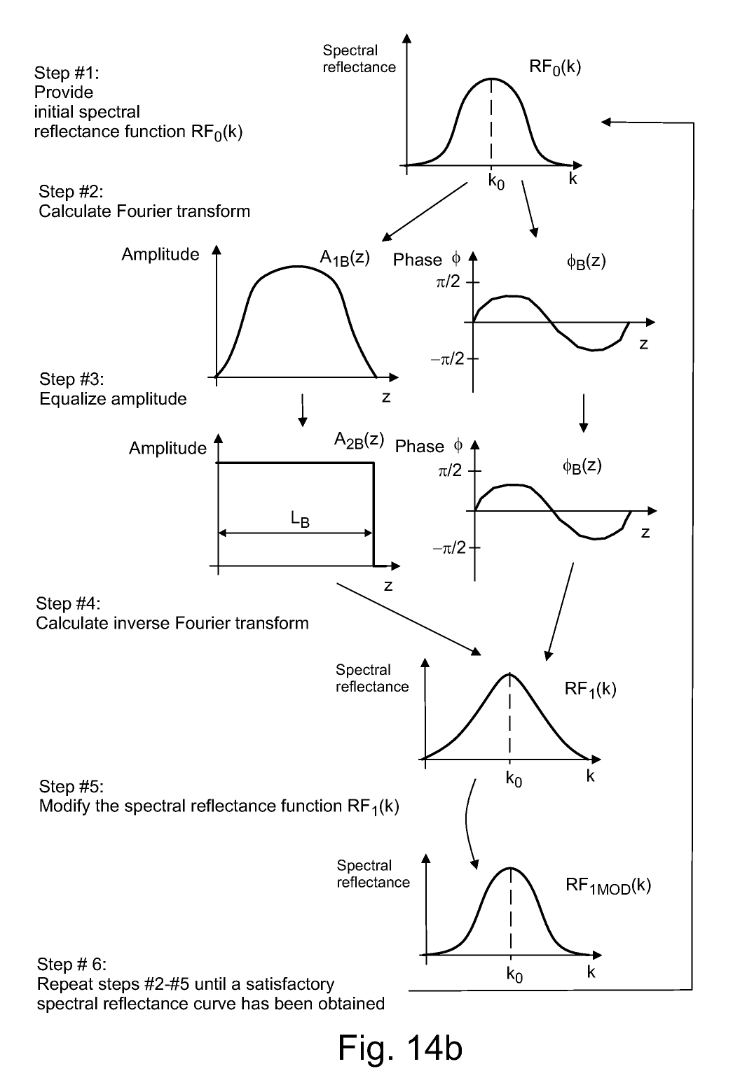

Referring to FIG. 14a, the length of the period Λ_{B}(z) of the Bragg grating may depend on the location of the period.

The length of the period Λ_{B}(z) may depend on the location z e.g. in a linear fashion, i.e. the period length may be linearly chirped.

Alternatively, the Bragg grating 80 may have a first region (REGB1) and a second region (REGB2) such that:
in the first region (REGB1), the length (Λ_{B}) of the period of the diffractive features (83) substantially increases with increasing distance (z) from an origin (ORIG),
in the second region (REGB2), the length (Λ_{B}) of the period of the diffractive features (83) substantially decreases with increasing distance (z) from the origin (ORIG).

Alternatively, the Bragg grating 80 may have a first region (REGB1) and a second region (REGB2) such that:
in the first region (REGB1), the length (Λ_{B}) of the period of the diffractive features (83) substantially decreases with increasing distance (z) from an origin (ORIG),
in the second region (REGB2), the length (Λ_{B}) of the period of the diffractive features (83) substantially increases with increasing distance (z) from the origin (ORIG).

The Bragg grating 80 may have a first region (REGB1), a second region (REGB2), and a third region (REGB3) such that:
in the first region (REGB1), the length (Λ_{B}) of the period of the diffractive features (83) substantially increases with increasing distance (z) from an origin (ORIG),
in the second region (REGB2), the length (Λ_{B}) of the period of the diffractive features (83) substantially decreases with increasing distance (z) from the origin (ORIG).
in the third region (REGB3), the length (Λ_{B}) of the period of the diffractive features (83) substantially increases with increasing distance (z) from an origin (ORIG),
   wherein second region (REGB2) is between the first region (REGB1) and the third region (REGB3).

Alternatively, the Bragg grating 80 may have a first region (REGB1), a second region (REGB2), and a third region (REGB3) such that:
in the first region (REGB1), the length (Λ_{B}) of the period of the diffractive features (83) substantially decreases with increasing distance (z) from an origin (ORIG),
in the second region (REGB2), the length (Λ_{B}) of the period of the diffractive features (83) substantially increases with increasing distance (z) from the origin (ORIG).
in the third region (REGB3), the length (Λ_{B}) of the period of the diffractive features (83) substantially decreases with increasing distance (z) from an origin (ORIG),
   wherein second region (REGB2) is between the first region (REGB1) and the third region (REGB3).

The period length function Λ_{B}(z) may be determined e.g. from the desired form of the spectral reflectance function RF(λ) by using the iterative Fourier transform algorithm shown in FIG. 14b.

In step #1, the algorithm of FIG. 14b may be started from an initial (desired) spectral reflectance function RF₀(k). The wavelength λ may be replaced with the wavenumber k (according to equation (3)).

In step #2, the Fourier transform of the reflectance function RF₀(k) may provide a first amplitude function A_{1B}(z) and a phase function φ_{B}(z).

In an optional step #3, a second amplitude function A_{2B}(z) may be provided by equalizing or otherwise modifying the first amplitude function A_{1B}(z). The constant amplitude corresponds to a situation where the diffractive features 83 have substantially equal size. However, e.g. the height or fill factor of the diffractive features 83 may be modulated so as to implement a non-constant amplitude function A_{2B}(z) (or A_{1B}(z)). The phase function φ_{B}(z) may be the same as in the step #2.

L_{B} denotes the total length of the Bragg grating. The total length L_{B} of the Bragg grating may be equal to the total length L_{T} of the poled zones 91. Alternatively, the total length L_{B} of the Bragg grating may be smaller than the total length L_{T} of the poled zones 91 (See e.g. FIG. 12a).

In step #4, a spectral reflectance function RF₁(k) may be determined by calculating an inverse Fourier transform from the functions A_{2B}(z) and φ_{B}(z).

If the form of the spectral reflectance function RF₁(k) is satisfactory, the period length Λ_{B} may be modulated according to the phase function φ_{B}(z) determined in step #2.

If the form and/or width of the function RF₁(k) is not acceptable, a modified function RF_{1MOD}(k) may be provided from the function RF₁(k). The modified function RF_{1MOD}(k) may be provided e.g. by modifying the (amplitude of) spectral reflectance values of the function RF₁(k). The spectral reflectance values of the function RF_{1MOD}(k) may be selected e.g. such that they are between the spectral reflectance values of the initial function RF₀(k) and the spectral reflectance values of the function RF₁(k)

In step #6, the (modified) function RF_{1MOD}(k) determined in step #5 may be used as a new initial function RF₀(k). The steps #2-#6 may be iteratively repeated until the form and/or width of the function RF₁(k) substantially matches with the desired form and/or width of the spectral reflectance function RF₀(k). Repeating the steps #2-#6 (iteratively) may be called as an iterative Fourier transform algorithm (IFTA).

The period length function Λ_{B}(z) may be determined such that it corresponds to the phase function φ_{B}(z). The period length function Λ_{B}(z) may be determined such that it corresponds to the phase function φ_{B}(z) after iteration.

Also in this case, the period length function Λ_{B}(z) may be (cyclically) shifted sideways and/or the period length function Λ_{B}(z) may be horizontally flipped.

The length of period of the diffractive features 83 may be varied according to the phase φ_{B}(z) of the Fourier transform of a spectral reflectance function RF(k). The length of period of the diffractive features 83 may be varied according to a phase function φ_{B}(z) which is horizontally flipped and/or which is (cyclically) shifted in the direction SZ or in the direction −SZ.

The locations of the diffractive features 83 of the Bragg grating 80 and the locations of the poled zones 91 do not need to be spatially synchronized. For example, the lengths of the diffractive features 83 selected according to the curve Λ_{B}(z) of FIG. 14a may be used in combination with the poled zones of FIG. 3b.

In FIG. 14a, Λ_{B,MAX} denotes the maximum value of the period of the diffractive features 83. z_{BMX} denotes the location where maximum value Λ_{B,MAX} is attained. Λ_{B,MIN} denotes the minimum value of the period of the diffractive features 83. z_{BMN} denotes the location where minimum value Λ_{B,MIN} is attained. Λ_{B,AVE} denotes the minimum value of the period of the diffractive features 83.

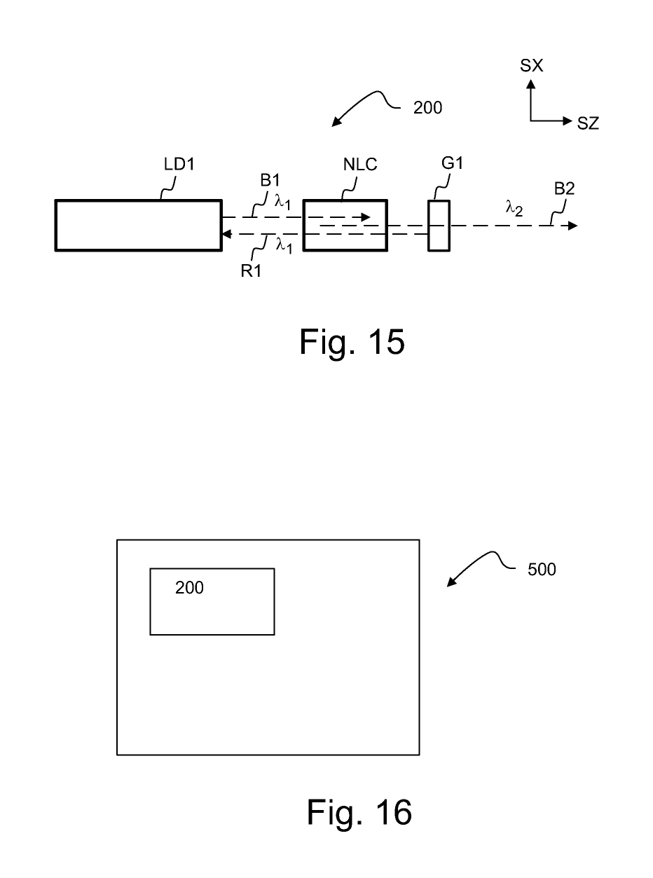

Referring to FIG. 15, the spectrally selective component may be a resonant grating G1, which is arranged to provide optical feedback R1 to the gain region 20 of the light emitting unit LD through the nonlinear crystal NLC.

Suitable resonant gratings have been described e.g. in a patent application PCT/FI2010/050674, herein incorporated by reference.

Referring back to FIGS. 9a and 10, a light emitting unit LD1 may comprise a waveguide 24 having a gain region 20. The light emitting unit LD1 may further comprise a semiconductor saturable absorber 40, a first reflecting structure 60, a beam directing structure M45, and a substrate. The combination of the saturable absorber 40 and the first reflecting structure 60 is also known by the acronym SESAM (semiconductor saturable absorber mirror). The gain region 20, the saturable absorber 40, and the inclined reflecting structure M45 may be implemented on the common substrate 10.

The light source 200 may comprise one or more nonlinear crystals NLC.

A light source 200 may comprise:
a waveguide 24 having an electrically pumped gain region 20,
a saturable absorber 40,
a beam directing structure M45,
a light-concentrating structure 120,
a substrate 10, and
a nonlinear crystal NLC,
   wherein the saturable absorber 40 and the gain region 20 are adapted to emit first light pulses B1, said beam directing structure M45 together with said light-concentrating structure 120 being adapted to couple said first light pulses B1 into said nonlinear crystal NLC, said nonlinear crystal NLC being adapted to generate second light pulses B2 such that the optical frequency of said second light pulses B2 is higher than the optical frequency of said first light pulses B1; said gain region 20, said saturable absorber 40, said directing structure M45, and said light-concentrating structure 120 being implemented on or in said substrate 10 such that said beam directing structure M45 is adapted to change the direction of said first light pulses B1 by an angle β1 which is in the range of 70 to 110 degrees.

The light emitting unit LD1 may provide light pulses B1 from a first end of the waveguide 24. The light pulses B1 may be coupled into the nonlinear crystal NLC in order to provide second light pulses B2 having a higher frequency when compared with the light pulses B1. The second light pulses B2 may be generated by sum frequency generation SFG. An individual pulse of said first light pulses B1 may have a first photon Bfa and a second photon Bfb. The optical frequency of a photon of a second light pulse B2 may be equal to the sum of an optical frequency of the first photon Bfa and an optical frequency of the second photon Bfb.

In particular, the second light pulses B2 may be generated by second harmonic generation SHG. The second light pulses B2 may have e.g. double optical frequency and half wavelength when compared with the light B1, i.e. to provide second harmonic generation (SHG). In other words, the nonlinear medium NLC may be adapted to generate second light such that the optical frequency of the light B2 provided by the nonlinear crystal is two times the optical frequency of the light B1. However, in case of wide band conversion, sum frequency generation (SFG) may dominate over second harmonic generation (SHG).

The beam directing structure M45 may be arranged to reflect the light beam B1 emitted from the waveguide 24 into the nonlinear crystal NLC. Light which propagates longitudinally in the waveguide is confined to said waveguide 24 by total internal reflections on the sides of the waveguide. The beam directing structure M45 may be arranged to change the direction of the light beam B1 by an angle β1 which is in the range of 70 to 110 degrees. In particular, said angle β1 may be substantially equal to 90 degrees. The beam directing structure M45 may be an inclined facet. The beam directing structure M45 may be implemented by an inclined end of the waveguide 24. The beam directing structure M45 may be a diffractive structure.

The light B1 may be collimated or focused by a light-concentrating structure 120 into the nonlinear crystal NLC.

The common substrate 10 may be substantially transparent at the wavelength or wavelengths of the light beam B1, in order to allow the beam B1 to pass vertically through said common substrate 10.

Positioning of the nonlinear crystal NLC onto a substantially horizontal surface of the substrate 10 may allow easier alignment of the crystal NLC with respect to the beam B1 than in a linear arrangement without the beam directing structure M45.

The back reflector 60 may be in contact with the waveguide 24 or there may be a space between them. The waveguide 24 may be in contact with the beam directing structure M45, or there may be a space between them. The saturable absorber 40 may be in contact with the gain region 20, or there may be a space between them.

The pulse repetition rate of the light pulses B1, B2 may be e.g. in the range of 100 MHz to 100 GHz. In particular, the pulse repetition rate may be in the range of 10 GHz to 100 GHz. The duration of the pulses may be in the order of 500 femtoseconds to 1 nanosecond (500 fs to 1 ns), while the energy of an individual light pulse may be kept smaller than 1 nJ (nanoJoule). Consequently, the peak power of an individual light pulse B2 emitted from the light source 200 be e.g. in the range of 0.5 W to 10 W. In particular, the peak power of an individual light pulse B2 may substantially equal to 1 W. The pulse repetition rate may also be in the range of 1 GHz to 500 GHz. The duration of the pulses may also be in the range of 1 ps to 10 ps. The peak power of an individual light pulse emitted from a light source 200 may also be in the range of 10 W to 50 W.

A very low speckle contrast may be achieved by providing short light pulses B1, B2. A reduction in the duration of the pulse may also lead to an increase in the peak intensity, and consequently to a greater efficiency of converting first light B1 into the second light B2 in the nonlinear crystal NLC.

The integration time of the human eye is typically in the range of 10 ms. If the pulse repetition rate of a single emitter is e.g. 10 GHz, the human eye may receive up to 100 million speckle patterns formed by short coherence length pulses per the integration period of 10 ms.

By using the saturable absorber the pulse repetition rate of a single emitter may be very high, e.g. 10 GHz. Thus, although the duration of an individual pulse is very short (e.g. 1 ps), the light source 200 may still provide a considerable average optical power.

The speckle contrast may be minimized by reducing the duration of the light pulses provided the light source 200. The use of short light pulses provides also a good efficiency of converting electrical energy into optical energy at visible wavelengths. In particular, very short light pulses may be provided when the emitted high-intensity pulses travel through the gain region 20 only once. This may be achieved e.g. by cavity dumping. The Bragg grating 80 may be adapted to provide frequency-selective optical feedback at the predetermined frequency of the fundamental light pulses B1, i.e. at the wavelength of said light pulses B1. The Bragg grating 80 may allow stabilization of the fundamental frequency and generation of light pulses by cavity dumping. Optical feedback provided by the combination of the nonlinear crystal NLC and the Bragg grating 80 is substantially smaller for the high-intensity light pulses than for the low-intensity light. Thanks to the intensity-dependent feedback, the fall time of the generated pulses may be very short. Consequently, very short and intense light pulses of visible light may be generated at a high efficiency.

Manufacturing, structure, and operation of the light emitting units LD1 has been described e.g. in a patent publication WO 2008/087253, herein incorporated by reference.

Referring to FIG. 16, a light source 200 comprising a nonlinear crystal NLC may be a part of an image projector 500 for projecting images on an external screen. Light B2 provided by the light source 200 may be modulated and/or directed such that a visible image may be formed on the external screen.

Alternatively, the light source 200 comprising a nonlinear crystal NLC may be a part of a display unit 500 for displaying images. The display unit may be e.g. a television or a virtual display. Light B2 provided by the light source 200 may be modulated and/or directed such that a visible image may be displayed.

Alternatively, the light source 200 comprising a nonlinear crystal NLC may be a part of a device 500 used for illumination. The device 500 may be a handheld portable torch. The device 500 may be a lamp of a vehicle, lamp of a ship, or a lamp of an airplane.

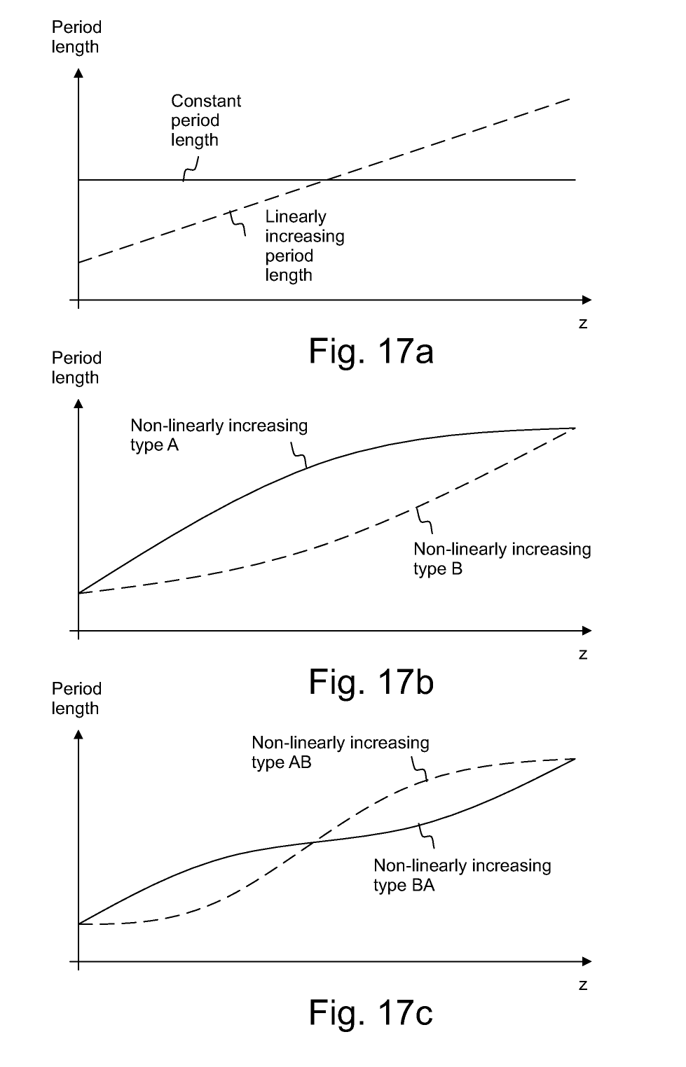

Referring to FIGS. 17a-17c, the poling periods may have a constant period length, a linearly increasing period length, a nonlinearly increasing period length, or the length may be varied according to the phase of a Fourier transform. The constant period length may provide the narrowest conversion efficiency curve. The linearly increasing period length or the nonlinearly increasing period length may provide a slightly wider conversion efficiency curve. The period lengths determined by using the Fourier transform may provide the widest conversion efficiency curve.

FIG. 17 shows a constant period length, and a linearly increasing period length. FIGS. 17b and 17c show various types of non-linearly increasing period length (Type A, type B, type AB, and type BA).

The diffractive features of the optical feedback structure 80 may have a constant period length, linearly increasing or decreasing period length, nonlinearly increasing or decreasing period length, or the length may be varied according to the phase of a Fourier transform. (Yet, in an embodiment, the nonlinear crystal NLC does not comprise an optical feedback structure). The constant period length may provide the narrowest spectral reflectance curve. The linearly increasing/decreasing period length or the nonlinearly increasing/decreasing period length may provide a slightly wider reflectance curve. The period lengths determined by using the Fourier transform may provide the widest reflectance curve.

In particular, very stable operation of the light source 200 may be obtained e.g. by using the following combination of features:
the lengths Λ_{P} of the poling periods are varied according to the phase φ_{P}(z) of a Fourier transform of a conversion efficiency function Eff(k), and
the lengths Λ_{B} of the periods of the diffractive features 83 of an optical feedback structure 80 are varied according to the phase φ_{B}(z) of a Fourier transform of a spectral reflectance function RF(k).

However, the light source 200 may also operate when:
the lengths Λ_{P} of the poling periods are varied according to a first linear function (linearly chirped poling period), and
the lengths Λ_{B} of the periods of the diffractive features are varied according to a second linear function (linearly chirped Bragg grating).

The curves of FIGS. 17a-17c may represent poling period functions or grating period functions. A crystal NLC may comprise poled periods and a Bragg grating such that any of increasing or decreasing poling period functions according to the FIGS. 17a-17c may be combined with any of the increasing or decreasing grating period functions according to the FIGS. 17a-17c.

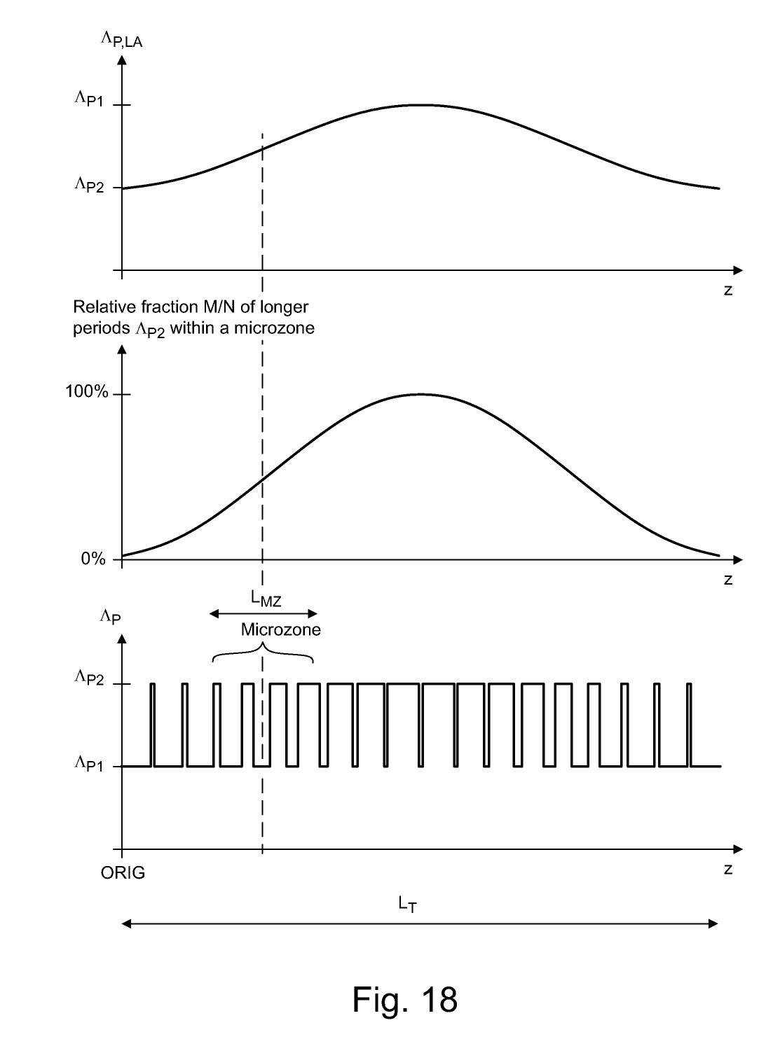

Referring to FIG. 18, the period lengths of the crystal may be quantized. An advantageous conversion efficiency curve Eff(λ) may also be provided by using only two different period lengths Λ_{P1} and Λ_{P2}. In this case, the local average Λ_{P,LA} of the period length Λ_{P} may be spatially varied such that a desired conversion efficiency curve Eff(λ) may be provided. Instead of varying the lengths of individual periods in a smooth manner, the local average Λ_{P,LA} of the period length Λ_{P} may be varied.

The local average Λ_{P,LA} may be determined e.g. by calculating the average value of the lengths A_{P} of N successive periods. The integer N may be e.g. in the range of 2 to 100. In particular, the local average Λ_{P,LA} may be determined e.g. by calculating the average value of the lengths Λ_{P} of one hundred successive periods.

The group of N successive periods may be called as a microzone. The length L_{MZ} of the microzone may be approximately equal to N×Λ_{P,AVE}, where Λ_{P,AVE} denotes the global average of all periods of the nonlinear crystal NLC.

A microzone may comprise two different period lengths Λ_{P1} and Λ_{P2}. The number M of periods having the longer period length Λ_{P2} within the microzone may be selected such that the local average Λ_{P,LA} reaches the desired value. The ratio M/N may be in the range of 0 to 100%.

A microzone may comprise two or more different period lengths Λ_{P1} and Λ_{P2}.

A microzone may comprise three or more different period lengths, and the number of periods having the different lengths within a single microzone may be selected such that the local average Λ_{P,LA reaches the desired value.}

The number of different period lengths applied within a single microzone may be substantially smaller than N.

Also a Bragg grating may be implemented by using two different period lengths within a microzone. a Bragg grating may be implemented by using three or more different period lengths within a microzone. The number of different period lengths applied within a single microzone may be substantially smaller than N. The local average may be determined e.g. by calculating the average value of the lengths Λ_{B} of N successive periods. The integer N may be e.g. in the range of 2 to 100.

The local average of the period length Λ_{B} may be spatially varied such that a desired spectral reflectance curve RF(λ) may be provided.

Thus, the local average Λ_{P,LA} and/or the local average Λ_{B,LA} may be varied as a function of the distance z from the origin ORIG, instead of varying the lengths Λ_{P}, Λ_{B} of individual poling periods and/or grating periods. In case of the above-mentioned FIGS. 3a-17c, the poling period function Λ_{P}(z) may be replaced with the local average function Λ_{P,LA}(z). In case of the above-mentioned FIGS. 3a-17c, the grating period function Λ_{B}(z) may be replaced with the local average function Λ_{B,LA}(z). The local average function Λ_{P,LA}(Z) defines the average values of the lengths Λ_{P} at different distances z from the origin ORIG. The local average function Λ_{B,LA}(z) defines the average values of the lengths Λ_{B} at different distances z from the origin ORIG.

The various aspects of the invention are illustrated by the following examples:

### Example 1

A device (200, NLC) comprising a plurality of poled zones (91) implemented in a nonlinear material, wherein the device (NLC) has a first region (REG1) and a second region (REG2) such that:

in the first region (REG1), the local average of the length (Λ_{P}) of the period of the poled zones (91) substantially increases with increasing distance (z) from an origin (ORIG),
in the second region (REG2), the local average of the length (Λ_{P}) of the period of the poled zones (91) substantially decreases with increasing distance (z) from the origin (ORIG).

### Example 2

The device (NLC) of example 1 wherein the device is a nonlinear crystal (NLC).

### Example 3

The device (NLC) of example 1 wherein the device is a light source (200) comprising a nonlinear crystal (NLC).

### Example 4

The device (NLC) according to any of the examples 1 to 3 comprising a third region (REG3) such that:
the second region (REG2) is between the first region (REG1) and the third region (REG3), and
in the third region (REG3), the local average of the length (Λ_{P}) of the period of the poled zones (91) substantially increases with increasing distance (z) from an origin (ORIG).

### Example 5

The device (NLC) according to any of the examples 1 to 4 comprising a waveguide (92), which comprises the poled zones (91).

### Example 6

The device (NLC) of example 5 comprising a proton-exchanged ridge waveguide (92).

### Example 7

The device (NLC) according to any of the examples 1 to 6 comprising a Bragg grating (80) arranged to provide optical feedback (R1).

### Example 8

The device (NLC) of example 7 wherein the reflection bandwidth of the Bragg grating (80) is broader and/or equal to the width (Δλ_{80%}) of the conversion efficiency curve (Eff(λ)) provided by the poled zones (91).

### Example 9

The device (NLC) of example 7 or 8 wherein the Bragg grating 80 is chirped.

### Example 10

The device (NLC) of example 7 or 8 wherein the Bragg grating 80 has a first region (REGB1) and a second region (REGB2) such that:
in the first region (REGB1), the local average of the length (Λ_{B}) of the period of the diffractive features (83) substantially increases with increasing distance (z) from an origin (ORIG), and
in the second region (REGB2), the local average of the length (Λ_{B}) of the period of the diffractive features (83) substantially decreases with increasing distance (z) from the origin (ORIG).

### Example 11

The device (NLC) of example 7 or 8 wherein the Bragg grating 80 has a first region (REGB1), a second region (REGB2), and a third region (REGB3) such that:
in the first region (REGB1), the local average of the length (Λ_{B}) of the period of the diffractive features (83) substantially increases with increasing distance (z) from an origin (ORIG),
in the second region (REGB2), the local average of the length (Λ_{B}) of the period of the diffractive features (83) substantially decreases with increasing distance (z) from the origin (ORIG).
in the third region (REGB3), the local average of the length (Λ_{B}) of the period of the diffractive features (83) substantially increases with increasing distance (z) from an origin (ORIG),
   wherein second region (REGB2) is between the first region (REGB1) and the third region (REGB3).

### Example 12

The device (NLC) of example 7 or 8 wherein the Bragg grating 80 has a first region (REGB1), a second region (REGB2), and a third region (REGB3) such that:
in the first region (REGB1), the local average of the length (Λ_{B}) of the period of the diffractive features (83) substantially decreases with increasing distance (z) from an origin (ORIG),
in the second region (REGB2), the local average of the length (Λ_{B}) of the period of the diffractive features (83) substantially increases with increasing distance (z) from the origin (ORIG).
in the third region (REGB3), the local average of the length (Λ_{B}) of the period of the diffractive features (83) substantially decreases with increasing distance (z) from an origin (ORIG),
   wherein second region (REGB2) is between the first region (REGB1) and the third region (REGB3).

### Example 13

The device (NLC) according to any of the examples 7 to 12 wherein the grating period function (Λ_{B}(z)) substantially corresponds to a phase of a Fourier transform of a spectral reflectance function (RF(k)) of the Bragg grating (80).

### Example 14

The device according to any of the examples 1 to 13 comprising a light emitting unit (LD1) arranged to provide first light (B1) into the poled zones (91).

### Example 15

The device of example 14 wherein the light emitting unit (LD1) comprises a combination of gain region (20) and a saturable optical absorber (40) arranged to provide pulsed light (B1).

### Example 16

The device of example 15 comprising a beam directing structure (M45) arranged to change the direction of light (B1) provided by the gain region (20).

### Example 17

The device according to any of the examples 1 to 16 wherein the lengths (Λ_{P}) of the periods of the poled zones (91) at different locations have been selected such that the width (Δλ_{80%}) of the conversion efficiency curve (Eff(λ)) at 80% of the maximum conversion efficiency value (Eff_{MAX}) is greater than or equal to 0.3 nm, preferably greater than or equal to 0.5 nm.

### Example 18

The device according to any of the examples 1 to 17 wherein a spatial variation of the local average of the length (Λ_{P}) of the period of the poled zones (91) substantially corresponds to a phase of a Fourier transform of a conversion efficiency function provided by the poled zones (91) of the device (NLC).

### Example 19

The device according to any of the examples 1 to 18 arranged to provide visible light (B2) by sum frequency generation.

### Example 20

The device according to any of the examples 1 to 18 arranged to provide ultraviolet light (B2) by sum frequency generation.

### Example 21

A method for emitting light (B2) by using the device (NLC, 200) according to any of the examples 1 to 20.

### Example 22

A method for producing a nonlinear crystal (NLC) comprising implementing a plurality of poled zones (91) in a nonlinear material, wherein the crystal (NLC) has a first region (REG1) and a second region (REG2) such that:
in the first region (REG1), the length (Λ_{P}) of the period of the poled zones (91) substantially increases with increasing distance (z) from an origin (ORIG),
in the second region (REG2), the length (Λ_{P}) of the period of the poled zones (91) substantially decreases with increasing distance (z) from the origin (ORIG).

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1-23. (canceled)

24. A crystal for wavelength conversion, comprising:
a plurality of poled zones, wherein the crystal has a first region and a second region such that:
in the first region, a local average of a length of a period of the poled zones substantially increases with increasing distance from an origin, and
in the second region, the local average of the length of the period of the poled zones substantially decreases with increasing distance from the origin, and
wherein the origin is located at an end of said crystal.

25. The crystal according to claim 24, further comprising:
a third region such that:
the second region is located between the first region and the third region, and
in the third region, the local average of the length of the period of the poled zones substantially increases with increasing distance from said origin.

26. The crystal according to claim 24, wherein the length of the first region is greater than or equal to 5% of a total length of the crystal, and wherein the length of the second region is greater than or equal to 5% of the total length of the crystal.

27. The crystal according to claim 24, wherein the lengths of the periods of the poled zones at different locations have been selected such that the width of a conversion efficiency curve at 80% of the maximum conversion efficiency value is greater than or equal to 0.3 nm.

28. The crystal according to claim 24, wherein a ratio of a width Δλ80% of the conversion efficiency function to a width ΔλFWHM is greater than or equal to 0.6, wherein the width Δλ80% denotes the width of the conversion efficiency curve at 80% of the maximum conversion efficiency value, and the width ΔλFWHM denotes the width of the conversion efficiency curve at 50% of the maximum conversion efficiency value.

29. The crystal according to claim 24, wherein a poling period function of the crystal substantially corresponds to a phase of an auxiliary function, and wherein the auxiliary function is obtained by calculating a Fourier transform of a shape function, which corresponds to a conversion efficiency function.

30. The crystal according to claim 24, wherein a poling period function of the crystal substantially corresponds to a phase of an auxiliary function, and wherein the auxiliary function has been determined such that a conversion efficiency function substantially corresponds to a function, which is equal to an amplitude of an inverse Fourier transform of the auxiliary function.

31. The crystal according to claim 24, wherein a locally averaged poling period function of the crystal substantially corresponds to a phase of an auxiliary function, and wherein the auxiliary function is obtained by calculating a Fourier transform of a shape function, which corresponds to the conversion efficiency function.

32. The crystal according to claim 24, wherein a locally averaged poling period function of the crystal substantially corresponds to a phase of an auxiliary function, and wherein the auxiliary function has been determined such that a conversion efficiency function substantially corresponds to a function, which is equal to an amplitude of an inverse Fourier transform of the auxiliary function.

33. The crystal according to claim 24, wherein a locally averaged poling period function of the crystal substantially corresponds to a phase of an auxiliary function, and wherein the auxiliary function is obtained by calculating a Fourier transform of a square root of an conversion efficiency function.

34. The crystal according to claim 24, wherein a locally averaged poling period function of the crystal substantially corresponds to a phase of an auxiliary function, and wherein the auxiliary function has been determined such that a conversion efficiency function is substantially proportional to a function, which is equal to a square of an amplitude of an inverse Fourier transform of the auxiliary function.

35. The crystal according to claim 24, wherein the lengths of the poling periods are quantized.

36. The crystal according to claim 24, further comprising:
a waveguide, which comprises the poled zones.

37. The crystal according to claim 36, further comprising:
a proton-exchanged ridge waveguide.

38. The crystal according to claim 24, further comprising:
a diffractive grating arranged to provide optical feedback.

39. The crystal according to claim 38, wherein a grating period function of the diffractive grating substantially corresponds to a phase of a Fourier transform of a spectral reflectance function of the diffractive grating.

40. A device, comprising:
a crystal for wavelength conversion, and
a light emitting unit,
wherein the crystal comprises a plurality of poled zones, and the crystal has a first region and a second region such that:
in the first region, a local average of a length of a period of the poled zones substantially increases with increasing distance from an origin, and
in the second region, the local average of the length of the period of the poled zones substantially decreases with increasing distance from the origin, and
wherein the origin is located at an end of said crystal, and wherein the light emitting unit is arranged to provide first light into the poled zones.

41. The device according to claim 40, wherein the light emitting unit comprises a combination of a gain region and a saturable optical absorber arranged to provide pulsed light.

42. The device according to claim 41, further comprising:
a beam directing structure arranged to change a direction of light provided by the gain region.

43. The device according to claim 40, wherein the device is arranged to provide visible light by sum frequency generation.

44. The device according to claim 40, wherein the device is arranged to provide ultraviolet light by sum frequency generation.

45. A method, comprising:
generating first light by using light emitting unit,
coupling the first light into a crystal, and
generating second light by wavelength conversion in the crystal,
wherein the crystal comprises a plurality of poled zones, and the crystal has a first region and a second region such that:
in the first region, a local average of a length of a period of the poled zones substantially increases with increasing distance from an origin, and
in the second region, the local average of the length of the period of the poled zones substantially decreases with increasing distance from the origin, and
wherein the origin is located at an end of said crystal.

46. A method, comprising:
producing a crystal by implementing a plurality of poled zones of the crystal in a nonlinear material, wherein the crystal has a first region and a second region such that:
in the first region, the length of the period of the poled zones substantially increases with increasing distance from an origin, and
in the second region, the length of the period of the poled zones substantially decreases with increasing distance from the origin, and
wherein the origin is located at an end of said crystal.
